(19) United States
(12) Patent Application Publication
(10) Pub. No.: US 2024/0381216 A1
(43) Pub. Date: Nov. 14, 2024

(54) User Equipment or Source Master Node, Network Nodes and Methods in a Wireless Communications Network

(71) Applicant: Telefonaktiebolaget LM Ericsson (publ), Stockholm (SE)

(72) Inventors: Cecilia Eklöf, Täby (SE); Icaro Leonardo Da Silva, Solna (SE); Jens Bergqvist, Linköping (SE); Liwei Qiu, Täby (SE)

(21) Appl. No.: 18/690,791

(22) PCT Filed: Aug. 29, 2022
(86) PCT No.: PCT/SE2022/050773

§ 371 Date: Mar. 11, 2024

Related U.S. Application Data
(60) Provisional application No. 63/244,750, filed on Sep. 16, 2021.

(51) Int. Cl. H04W 36/36; H04W 76/20

(52) U.S. Cl. CPC H04W 36/362; H04W 76/20

(57) ABSTRACT

A method for indicating a Secondary Cell Group (SCG) state during a Conditional Handover (CHO) in a wireless communications network is provided. The method is performed by a User Equipment (UE), or by a source Master Node (MN). The UE is configured with a current SCG. A CHO configuration for the UE is obtained (1201) from a source MN. The CHO configuration comprises a configuration for a target candidate node. The target candidate node comprises any one or more out of: a target candidate MN and a target candidate Secondary Node (SN). When CHO execution conditions related to the CHO configuration are fulfilled, an indication is sent (1204) to the target candidate node. The indication indicates an SCG state being set to any one out of: SCG activated or SCG deactivated.

### TECHNICAL FIELD

Embodiments herein relate to a User Equipment (UE) or a source Master Node (MN), a first network node, a second network node, a third network node, and methods therein. In some aspects, they relate to indicating and/or handling a Secondary Cell Group (SCG) state during a Conditional Handover (CHO) for a UE in a wireless communications network.

Embodiments herein further relates to computer programs and carriers corresponding to the above methods, UE, and network node.

### BACKGROUND

In a typical wireless communication network, wireless devices, also known as wireless communication devices, mobile stations, stations (STA) and/or User Equipments (UE) s, communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point or a radio base station (RBS), which in some networks may also be denoted, for example, a NodeB, eNodeB (eNB), or gNB as denoted in Fifth Generation (5G) telecommunications. A service area or cell area is a geographical area where radio coverage is provided by the radio network node. The radio network node communicates over an air interface operating on radio frequencies with the wireless device within range of the radio network node.

3GPP is the standardization body for specify the standards for the cellular system evolution, e.g., including 3G, 4G, 5G and the future evolutions. Specifications for the Evolved Packet System (EPS), also called a Fourth Generation (4G) network, have been completed within the 3rd Generation Partnership Project (3GPP). As a continued network evolution, the new releases of 3GPP specifies a 5G network also referred to as 5G New Radio (NR).

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station, the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. Such systems and/or related techniques are commonly referred to as MIMO.

### 3GPP Dual Connectivity

In 3GPP Release12, an LTE feature Dual Connectivity (DC) was introduced, to enable a UE to be connected in two cell groups, each controlled by an LTE access node, eNBs, labelled as the Master eNB (MeNB) and the Secondary eNB (SeNB). The UE still only has one Radio Resource Control (RRC) connection with the network. In 3GPP, the Dual Connectivity (DC) solution has since then been evolved and is now also specified for NR as well as between LTE and NR. Multi-connectivity (MC) is the case when there are more than 2 nodes involved. With introduction of 5G, the term Multi-Radio Dual Connectivity (MR-DC), see also 3GPP TS 37.340, was defined as a generic term for all dual connectivity options which includes at least one NR access node. Using the MR-DC generalized terminology, the UE is connected in a Master Cell Group (MCG), controlled by the Master Node (MN), and in a Secondary Cell Group (SCG) controlled by a Secondary Node (SN).

Further, in MR-DC, when dual connectivity is configured for the UE, within each of the two cell groups, MCG and SCG, carrier aggregation may be used as well. In this case, within the Master Cell Group, MCG, controlled by the Master Node (MN), the UE may use one Primary Cell (Pcell) and one or more Secondary Cell(s) (SCell(s)). And within the Secondary Cell Group, SCG, controlled by a Secondary Node (SN), the UE may use one Primary SCell (PSCell), also known as the primary SCG cell in NR, and one or more SCell(s). This combined case is illustrated in FIG. 1, which illustrates dual connectivity combined with carrier aggregation in MR-DC. In NR, the primary cell of a master or secondary cell group is sometimes also referred to as the Special Cell (SpCell). Hence, the SpCell in the MCG is the PCell and the SpCell in the SCG is the PSCell.

There are different ways to deploy 5G network with or without interworking with LTE, also referred to as Evolved Universal Terrestrial Radio Access (E-UTRA), and Evolved Packet Core (EPC). In principle, NR and LTE may be deployed without any interworking, denoted by NR Stand-Alone (SA) operation, also known as Option 2, that is gNB in NR may be connected to 5G core network (5GC) and eNB in LTE may be connected to EPC with no interconnection between the two, also known as Option 1.

On the other hand, the first supported version of NR uses dual connectivity, denoted as E-UTRAN-NR Dual Connectivity (EN-DC), also known as Option 3, as depicted in FIG. 2. In such a deployment, dual connectivity between NR and LTE is applied, where the UE is connected with both the LTE radio interface, LTE Uu in the figure, to an LTE access node and the NR radio interface, NR Uu in the figure, to an NR access node. Further, in EN-DC, the LTE access node acts as the master node, in this case known as the Master eNB, MeNB, controlling the MCG and the NR access node acts as the secondary node, in this case sometimes also known as the Secondary gNB (SgNB) controlling the secondary cell group, SCG. The SgNB may not have a control plane connection to the core network (EPC) which instead is provided MeNB and in this case the NR. This is also called as “Non-standalone NR” or, in short, “NSA NR”. Notice that in this case the functionality of an NR cell is limited and would be used for connected mode UEs as a booster and/or diversity leg, but an RRC_IDLE UE cannot camp on these NR cells.

With introduction of 5GC, other options may be also valid. As mentioned above, option 2 supports stand-alone NR deployment where gNB is connected to 5GC. Similarly, LTE can also be connected to 5GC using option 5, also known as eLTE, E-UTRA/5GC, or LTE/5GC and the node can be referred to as an ng-eNB. In these cases, both NR and LTE are seen as part of the NG-RAN, and both the ng-eNB and the gNB may be referred to as NG-RAN nodes.

It is worth noting that, there are also other variants of dual connectivity between LTE and NR which have been standardized as part of NG-RAN connected to 5GC. Under the MR-DC umbrella, we have:
EN-DC (Option 3): LTE is the master node and NR is the secondary node (EPC CN employed, as depicted in FIG. 2)
NE-DC (Option 4): NR is the master node and LTE is the secondary (5GCN employed)
NGEN-DC (Option 7): LTE is the master node and NR is the secondary (5GCN employed).
NR-DC (variant of Option 2): Dual connectivity where both the master node, MN, controlling the MCG, and the secondary node, SN, controlling the SCG, are NR 5GCN employed, as depicted in FIG. 3.

As migration for these options may differ from different operators, it is possible to have deployments with multiple options in parallel in the same network e.g., there may be eNB base station supporting option 3, 5 and 7 in the same network as NR base station supporting 2 and 4. In combination with dual connectivity solutions between LTE and NR it is also possible to support Carrier Aggregation (CA) in each cell group, i.e. MCG and SCG, and dual connectivity between nodes on same RAT, e.g., NR-NR DC. For the LTE cells, a consequence of these different deployments is the co-existence of LTE cells associated to eNBs connected to EPC, 5GC or both EPC/5GC.

As said earlier, DC is standardized for both LTE and E-UTRA-NR DC (EN-DC).

LTE DC and EN-DC are designed differently when it comes to which nodes control what. Basically, there are two options:
1. Centralized solution (like LTE-DC),
2. Decentralized solution (like EN-DC).

FIG. 4 shows the schematic control plane architecture looks like for LTE DC, EN-DC and NR-DC. The main difference here is that in EN-DC and NR-DC, the SN has a separate NR RRC entity. This means that the SN can control the UE also; sometimes without the knowledge of the MN but often the SN need to coordinate with the MN. In LTE-DC, the RRC decisions are always coming from the MN (MN to UE). Note however, the SN still decides the configuration of the SN, since it is only the SN itself that has knowledge of what kind of resources, capabilities etc. it has.

For EN-DC and NR-DC, the major changes compared to LTE DC are:
The introduction of split bearer from the SN (known as SCG split bearer).
The introduction of split bearer for RRC
The introduction of a direct RRC from the SN (also referred to as SCG SRB)

FIG. 5 shows, from network perspective, the user plane protocol architecture in MR-DC with EPC (EN-DC). In this case, the network can configure either E-UTRA Packet Data Convergence Protocol (PDCP) or NR PDCP for MN terminated MCG bearers while NR PDCP is always used for all other bearers.

FIG. 6 shows, from network perspective, the user plane protocol architecture in MR-DC with 5GC (NGEN-DC, NE-DC and NR-DC). In MR-DC with 5GC, NR PDCP is always used for all bearer types. In NGEN-DC, E-UTRA Radio Link Control (RLC)/Medium Access Control (MAC) is used in the MN while NR RLC/MAC is used in the SN. In NE-DC, NR RLC/MAC is used in the MN while E-UTRA RLC/MAC is used in the SN. In NR-DC, NR RLC/MAC is used in both MN and SN. SDAP means Service Data Adaptation Protocol.

### Conditional Handover

In 3GPP Release16, conditional handover was standardized as a solution to increase the robustness at handover (HO). In order to avoid the undesired dependence on the serving radio link upon the time (and radio conditions) where the UE should execute the handover, the possibility to provide RRC signaling for the handover to the UE earlier was standardized. It is possible to associate the HO command with a condition e.g., based on radio conditions possibly similar to the ones associated to an A3 event, where a given neighbour becomes X dB better than target. As soon as the condition is fulfilled, the UE executes the handover in accordance with the provided handover command.

Such a condition may e.g., be that the quality of the target cell or beam becomes X dB stronger than the serving cell. The threshold Y used in a preceding measurement reporting event should then be chosen lower than the one in the handover execution condition. This allows the serving cell to prepare the handover upon reception of an early measurement report and to provide the RRC Connection Reconfiguration (RRCConnectionReconfiguration) with mobility Control Information (mobilityControlInfo) at a time when the radio link between the source cell and the UE is still stable. The execution of the handover is done at a later point in time (and threshold) which is considered optimal for the handover execution.

FIG. 7 depicts an example with just a serving and a target cell. In practice there may often be many cells or beams that the UE reported as possible candidates based on its preceding RRM measurements. The network should then have the freedom to issue conditional handover commands for several of those candidates. The RRCConnectionReconfiguration for each of those candidates may differ e.g., in terms of the HO execution condition (RS to measure and threshold to exceed) as well as in terms of the RA preamble to be sent when a condition is met.

While the UE evaluates the condition, it continues operating per its current RRC configuration, i.e., without applying the conditional HO command. When the UE determines that the condition is fulfilled, it disconnects from the serving cell, applies the conditional HO command and connects to the target cell. These steps are equivalent to the legacy handover execution.

### Conditional PSCell Change (CPC) 3GPP Release 16

A solution for CPC procedure was also standardized in Rel-16. Therein a UE operating in Multi-Radio Dual Connectivity (MR-DC) receives in a conditional reconfiguration one or multiple RRC Reconfiguration(s) (e.g., an RRCReconfiguration message) containing an SCG configuration, e.g., an secondaryCellGroup of Information Element (IE) CellGroupConfig, with a reconfigurationWithSync that is stored and associated to an execution condition (e.g., a condition like an A3/A5 event configuration), so that one of the stored messages is only applied upon the fulfillment of the execution condition e.g., associated with the serving PSCell, upon which the UE would perform PSCell change (in case it find a neighbour cell that is better than the current SpCell of the SCG).

### Inter-SN CPC in 3GPP Release 17

In 3GPP Release 17 solutions for inter-SN CPC is being discussed. One of the solutions, the so called Solution 1, has the signalling flow illustrated in FIG. 8.

### SUMMARY

As a part of developing embodiments herein the inventors identified a problem which first will be discussed.

In legacy handover of 3GPP Release 15 mobility, the UE receives a reconfiguration, applies it and accesses a target cell. Hence, if the target candidate that prepared the configuration would determine that the SCG state/mode of operation is to be deactivated due to current traffic demands, that would remain unchanged when the UE applies the generated message. An SCG state when used herein, may e.g., comprise SCG activated or SCG deactivated. An SCG state may also be referred to as SCG mode of operation. However, in conditional handover, the time the target candidate generates the configuration, and determines the SCG state, and the time the UE applies the target configuration may significantly differ, so when the UE applies a possibly deactivated SCG the traffic conditions may have changed so that the target candidate will immediately activate the SCG after execution. In conclusions, as the SCG state update for the ongoing connection is something that should be more dynamic than the decision to perform a handover, a solution where the UE configuration is updated every time the SCG state is changed may lead to a lot of signaling between the UE and the network, and also in the network, between source MN and target candidate MN, between target candidate MN and target candidate SN(s). And, due to differences in delay, it may lead to race conditions.

For example, let us assume that the UE configured with MR-DC is being configured with CHO, wherein at least one target candidate configuration, e.g., RRC Reconfiguration to be applied, contains MR-DC configurations. When CHO was configured, the SCG state was deactivated and the target candidate(s) follows that when generating the SCG configurations to be stored at the UE and applied upon execution. As the UE starts to monitor the execution conditions, the MN and or the S-SN may decide to activate the SCG, due to an increase in traffic demands. Hence, the consequences may be twofold in implementations using the currently assume protocol solutions based on 3GPP agreements so far in this area:
A) The UE applies the target SCG configuration with a sub-optimal state, e.g., deactivated when it should have been activated, which will lead to another signaling procedure right after the CHO execution. This is illustrated in FIG. 9.
B) To prevent A), the MN and/or the S-SN, upon triggering a change in the SCG state, e.g., from deactivated to activated, while the UE is configured with CHO containing and MR-DC configuration, will trigger a modification procedure to each target candidate SN, so that each target candidate SN may update the SCG reconfiguration to be applied upon execution, upon fulfillment of execution conditions. And after having obtained the updated SCG reconfiguration providing it to the UE. Hence, this would increase N times the number of CHO procedures both in Xn interface between the source MN and target candidate MN and between the target candidate MN and the SN candidate, and between the network and the UE, wherein N is the number of times the SCG state is changed while the UE is configured with CHO. Moreover, as these procedures may take time, this would increase the risk of race conditions i.e. CHO executions while the network is obtaining new SCG reconfigurations with a new state. This is illustrated in FIG. 10.

An object of embodiments herein is e.g., to improve the performance of a wireless communications network using CHO with multi-radio dual connectivity.

According to an aspect, the object is achieved by a method for indicating a Secondary Cell Group, SCG, state during a Conditional Handover, CHO, in a wireless communications network. The method is performed by a User Equipment, UE, or by a source MN. The UE is configured with a current SCG. A CHO configuration for the UE is obtained from a source MN. The CHO configuration comprises a configuration for a target candidate node. The target candidate node comprises any one or more out of: a target candidate Master Node, MN, and a target candidate Secondary Node, SN. when CHO execution conditions related to the CHO configuration are fulfilled, an indication is sent to the target candidate node. The indication indicates an SCG state being set to any one out of: SCG activated or SCG deactivated.

According to another aspect, the object is achieved by a method performed by a first network node acting as a source Master Node, MN. The method is for handling a Secondary Cell Group, SCG, state during a Conditional Handover, CHO, for a User Equipment, UE, in a wireless communications network. The UE is configured with a current SCG. A Conditional Handover, CHO, configuration for the UE is sent to the UE. The CHO configuration comprises a configuration for a target candidate node. The target candidate node comprises any one or more out of: A target candidate MN and a target candidate Secondary Node, SN. The CHO configuration triggers the UE to, when CHO execution conditions relating to the CHO configuration are fulfilled, send an indication to the target candidate node. The indication indicates an SCG state being set to any one out of: SCG activated or SCG deactivated.

According to another aspect, the object is achieved by a method performed by a second network node acting as a target Master Node, MN. The method is for handling a Secondary Cell Group, SCG, state during a Conditional Handover, CHO, for a User Equipment, UE, in a wireless communications network. The UE is configured with a current SCG. When CHO execution conditions relating to a CHO configuration are fulfilled, an indication is received from the UE. The indication indicates an SCG state being set to any one out of: SCG activated or SCG deactivated.

According to another aspect, the object is achieved by a method performed by a third network node acting as a target Secondary Node, SN. The method is for handling a Secondary Cell Group, SCG, state during a Conditional Handover, CHO, for a User Equipment, UE, in a wireless communications network. The UE is configured with a current SCG. When CHO execution conditions relating to a CHO configuration are fulfilled, an indication is received from the UE. The indication indicates an SCG state being set to any one out of: SCG activated or SCG deactivated.

According to another aspect, the object is achieved by any one out of a User Equipment, UE, or a source Master Node, MN, configured to indicate a Secondary Cell Group, SCG, state during a Conditional Handover, CHO, in a wireless communications network. The UE or source MN is configured with a current SCG, the UE or source MN further being configured to:
Obtain from a source MN, a Conditional Handover, CHO, configuration for the UE. The CHO configuration is adapted to comprise a configuration for a target candidate node. The target candidate node is arranged to comprise any one or more out of: A target candidate MN, and a target candidate Secondary Node, SN.
When CHO execution conditions related to the CHO configuration are adapted to be fulfilled, send an indication to the target candidate node, which indication is adapted to indicate an SCG state being set to any one out of: SCG activated or SCG deactivated.

According to another aspect, the object is achieved by a first network node acting as a source Master Node, MN, configured to handle a Secondary Cell Group, SCG, state during a Conditional Handover, CHO, for a User Equipment, UE, in a wireless communications network. The UE is arranged to be configured with a current SCG, the first network node is further configured to:
Send to the UE, a Conditional Handover, CHO, configuration for the UE. The CHO configuration is adapted to comprise a configuration for a target candidate node. The target candidate node is arranged to comprise any one or more out of: A target candidate Master Node, MN, and a target candidate Secondary Node, SN.
The CHO configuration is adapted to trigger the UE to, when CHO execution conditions relating to the CHO configuration are adapted to be fulfilled, send an indication to the target candidate node. The indication is adapted to indicate an SCG state being set to any one out of: SCG activated or SCG deactivated.

According to another aspect, the object is achieved by a second network node acting as a target Master Node, MN, configured to handle a Secondary Cell Group, SCG, state during a Conditional Handover, CHO, for a User Equipment, UE, in a wireless communications network. The UE is adapted to be configured with a current SCG, the second network node is further configured to:
When CHO execution conditions relating to a CHO configuration are adapted to be fulfilled, receive an indication from the UE. The indication is adapted to indicate an SCG state being set to any one out of: SCG activated or SCG deactivated.

According to another aspect, the object is achieved by a third network node acting as a target Secondary Node, SN, configured to handle a Secondary Cell Group, SCG, state during a Conditional Handover, CHO, for a User Equipment, UE, in a wireless communications network. The UE is adapted to be configured with a current SCG. The third network node is further configured to:
When CHO execution conditions relating to a CHO configuration are adapted to be fulfilled, receive an indication from the UE. The indication is adapted to indicate an SCG state being set to any one out of: SCG activated or SCG deactivated.

Some advantages of embodiments herein e.g., comprise:

Embodiment herein enables the target MN 112, upon CHO execution, to inform the T-SN about the current SCG state. By sending this information upon execution, the CHO configurations e.g., stored in the UE 120 do not have to be updated every time the SCG state changes. That may prevent a lot of signaling towards the UE 120 and in the network between the source MN 111 and target candidate MNs 112, and between the target candidate MNs 112 and candidate T-SNs 113.

### BRIEF DESCRIPTION OF THE DRAWINGS

FIG. 1 is a schematic block diagram depicting an example of prior art.

FIG. 2 is a schematic block diagram depicting an example of prior art.

FIG. 3 is a schematic block diagram depicting an example of prior art.

FIG. 4 is a schematic block diagram depicting an example of prior art.

FIG. 5 is a schematic block diagram depicting an example of prior art.

FIG. 6 is a schematic block diagram depicting an example of prior art.

FIG. 7 is a signaling diagram depicting an example of prior art.

FIG. 8 is a signaling diagram depicting an example of prior art.

FIG. 9 is a signaling diagram depicting an example of prior art.

FIG. 10 is a signaling diagram depicting an example of prior art.

FIG. 11 is a schematic block diagram depicting embodiments of a wireless communication network.

FIG. 12 is a flow chart depicting embodiments of a method in a UE or a source MN.

FIG. 13 is a flow chart depicting embodiments of a method in a first network node.

FIG. 14 is a flow chart depicting embodiments of a method in a second network node.

FIG. 15 is a flow chart depicting embodiments of a method in a third network node.

FIG. 16 is a signaling diagram depicting an example embodiments

FIGS. 17 a and b are schematic block diagrams depicting embodiments of a UE or a source MN.

FIGS. 18 a and b are schematic block diagrams depicting embodiments of a first network node.

FIGS. 19 a and b are schematic block diagrams depicting embodiments of a second network node.

FIGS. 20 a and b are schematic block diagrams depicting embodiments of a third network node.

FIG. 21 schematically illustrates a telecommunication network connected via an intermediate network to a host computer.

FIG. 22 is a generalized block diagram of a host computer communicating via a base station with a user equipment over a partially wireless connection.

FIGS. 23 to 26 are flowcharts illustrating methods implemented in a communication system including a host computer, a base station and a user equipment.

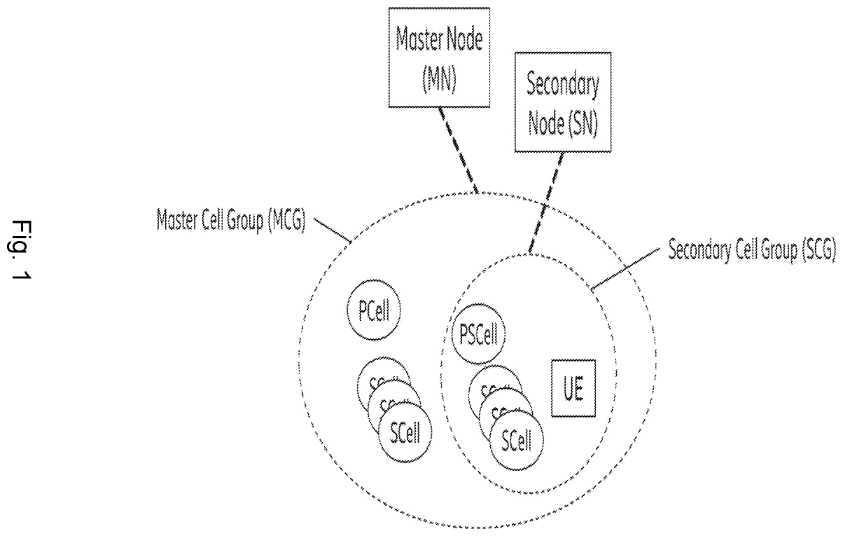

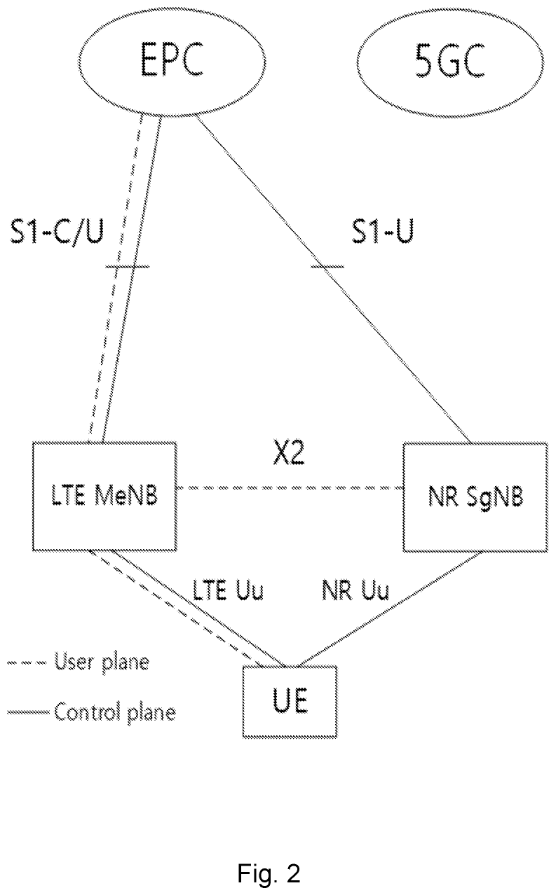

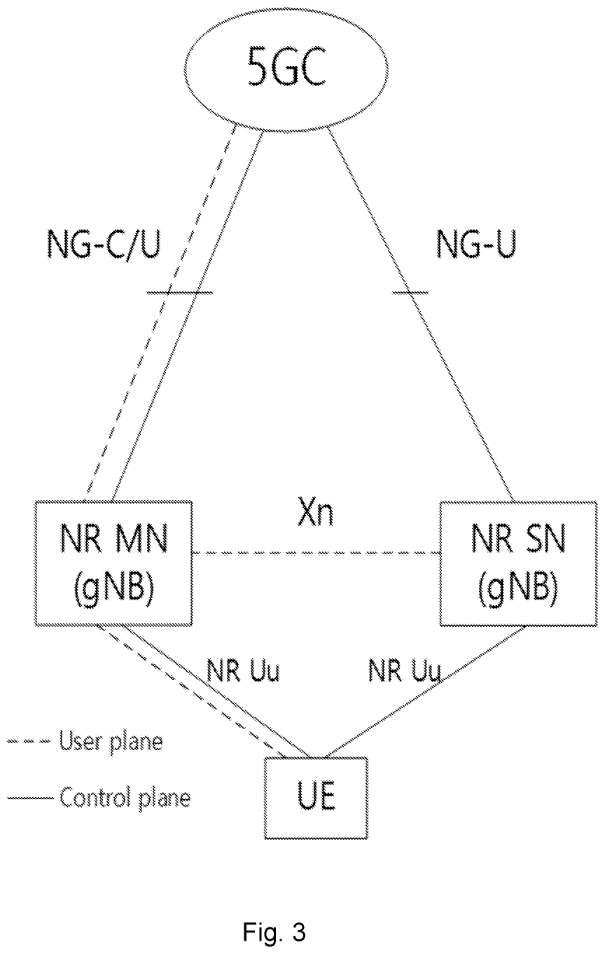

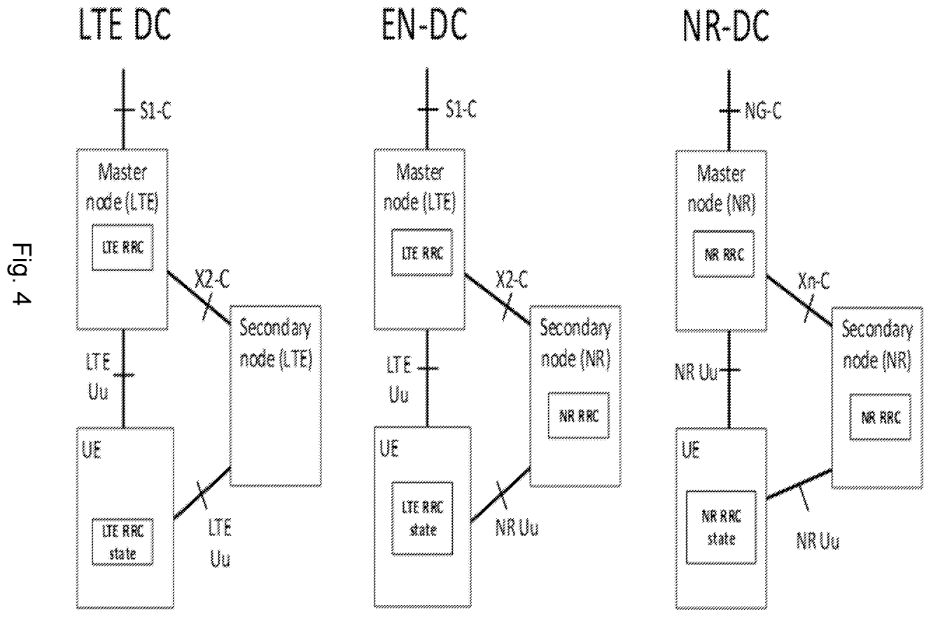

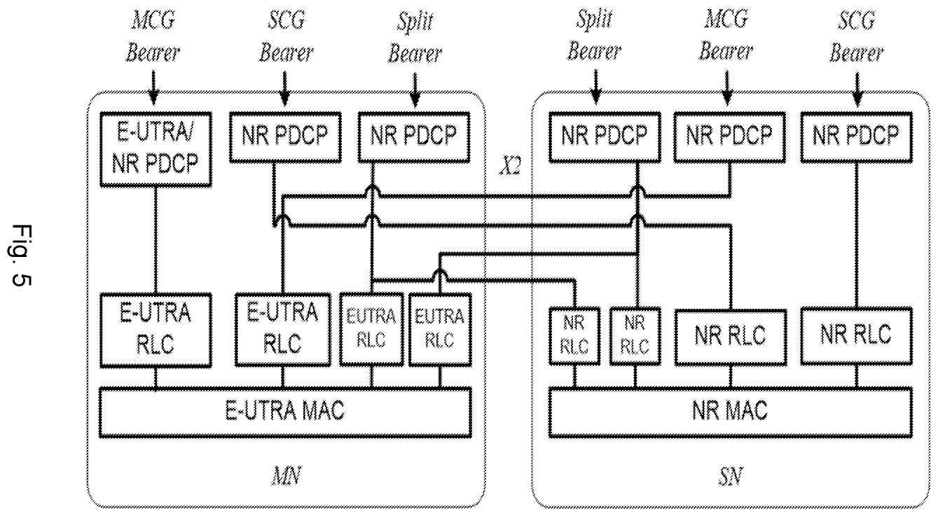

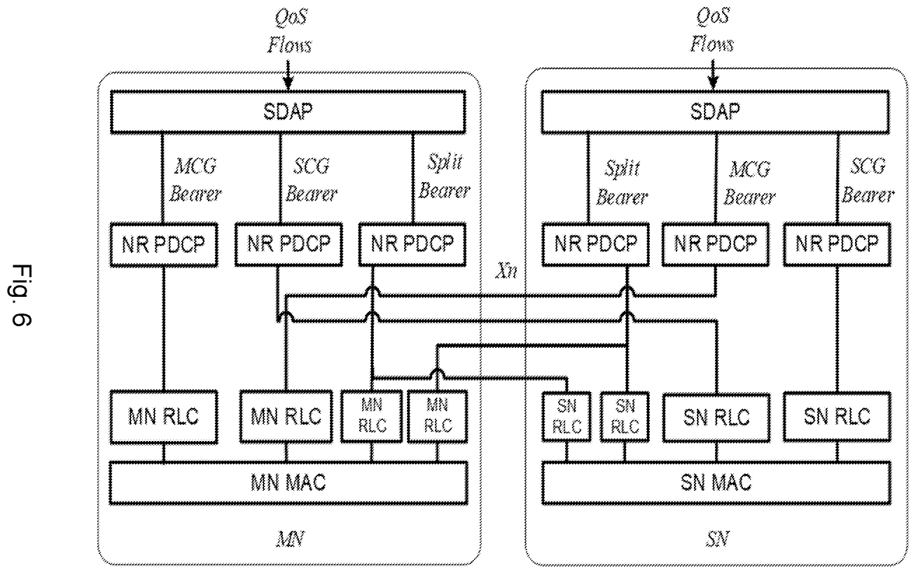

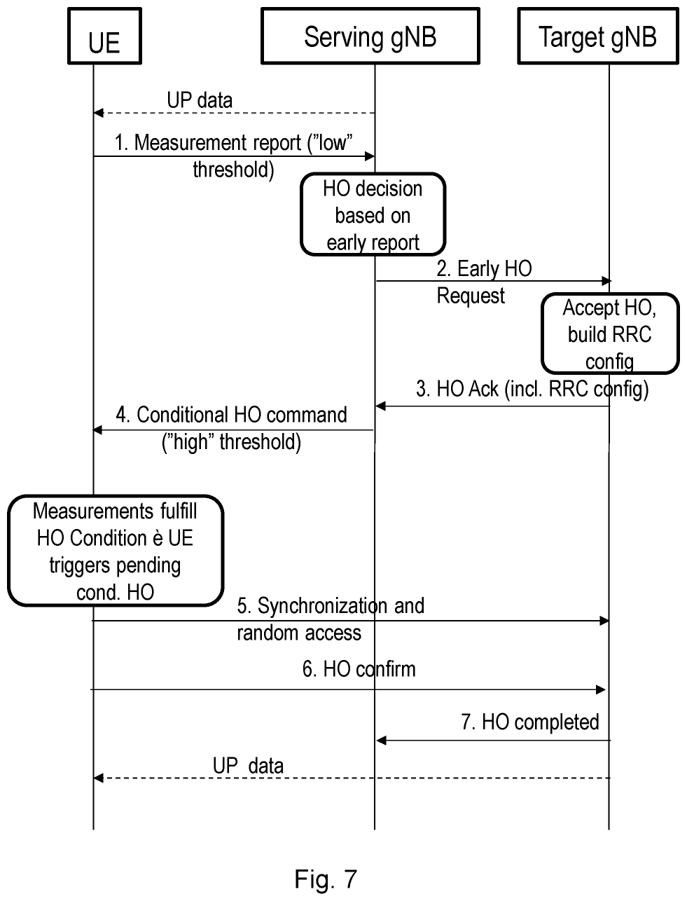

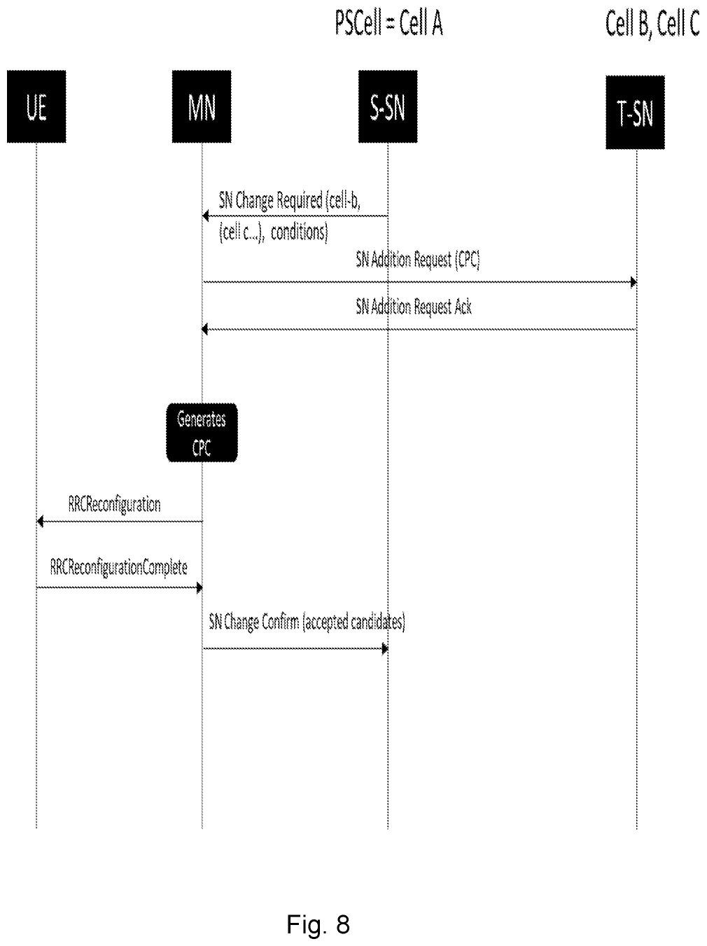

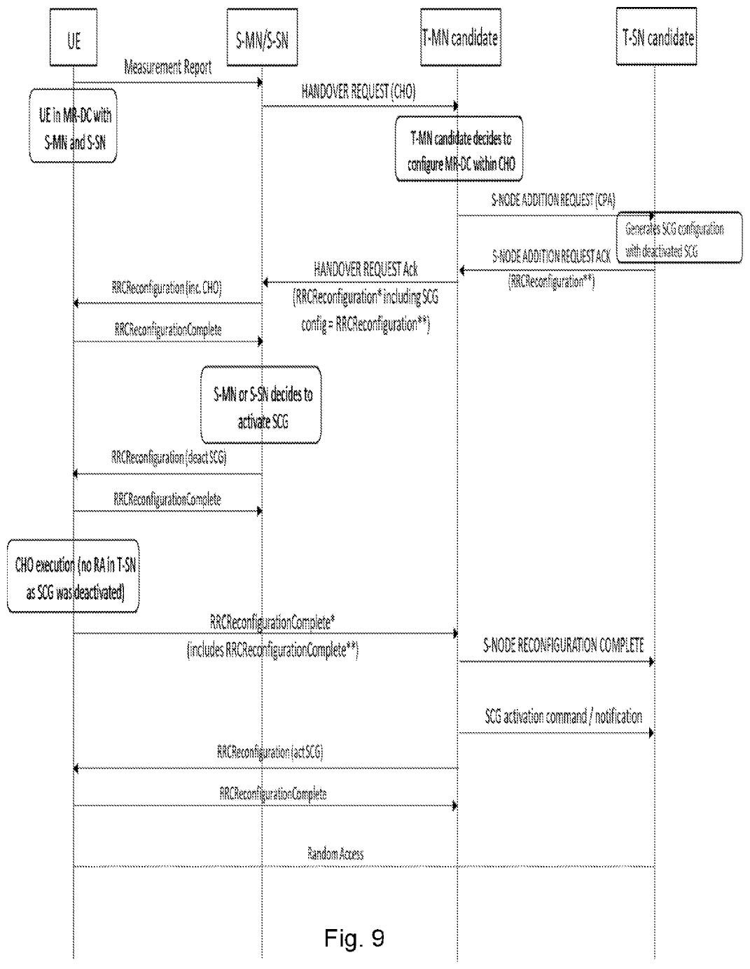

### DETAILED DESCRIPTION

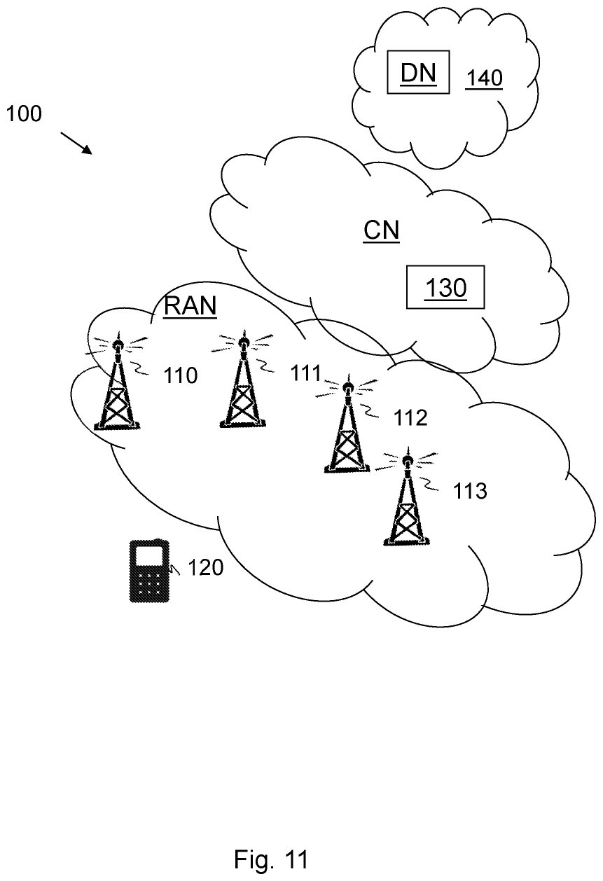

FIG. 11 is a schematic overview depicting a wireless communications network 100 wherein embodiments herein may be implemented. The wireless communications network 100 comprises one or more RANs and one or more CNs. The wireless communications network 100 may use 5G NR but may further use a number of other different technologies, such as, Wi-Fi, LTE, LTE-Advanced, Wideband Code Division Multiple Access (WCDMA), Global System for Mobile communications/enhanced Data rate for GSM Evolution (GSM/EDGE), or Ultra Mobile Broadband (UMB), just to mention a few possible implementations.

Network nodes such as a first network node 111 and a second network node 112 and a third network node 113 operate in the wireless communications network 100, by means of antenna beams, referred to as beams herein. The first, second and third network node 111, 112, 113, respectively e.g., provides a number of cells and may use these cells for communicating with e.g., a UE 120. The first, second and third network node 111, 112, 113, may respectively be a transmission and reception point e.g., a radio access network node such as a base station, e.g., a radio base station such as a NodeB, an evolved Node B (eNB, eNodeB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point, an Access Point Station (AP STA), an access controller, a UE acting as an access point or a peer in a Device to Device (D2D) communication, or any other network unit capable of communicating with a UE served by the respective first and second network nodes 111, 112, depending e.g., on the radio access technology and terminology used.

The first network node 111 may be acting as a source MN, the second network node 112 may be acting as a target MN 112, and the third network node 113 may be acting as a target SN.

UEs operate in the wireless communications network 100, such as a UE 120. The UE 120 may be configured with MR-DC, e.g., to communicate with an MCG controlled by an MN and an SCG controlled by an SN, e.g., the first and second network nodes 111, 112. The UE 120 may e.g., be an NR device, a mobile station, a wireless terminal, an NB-IoT device, an eMTC device, an NR RedCap device, a CAT-M device, a Wi-Fi device, an LTE device and a non-access point (non-AP) STA, a STA, that communicates via a base station such as e.g., the network node 110, one or more Access Networks (AN), e.g., RAN, to one or more core networks (CN). It should be understood by the skilled in the art that the UE relates to a non-limiting term which means any UE, terminal, wireless communication terminal, user equipment, (D2D) terminal, or node e.g., smart phone, laptop, mobile phone, sensor, relay, mobile tablets or even a small base station communicating within a cell.

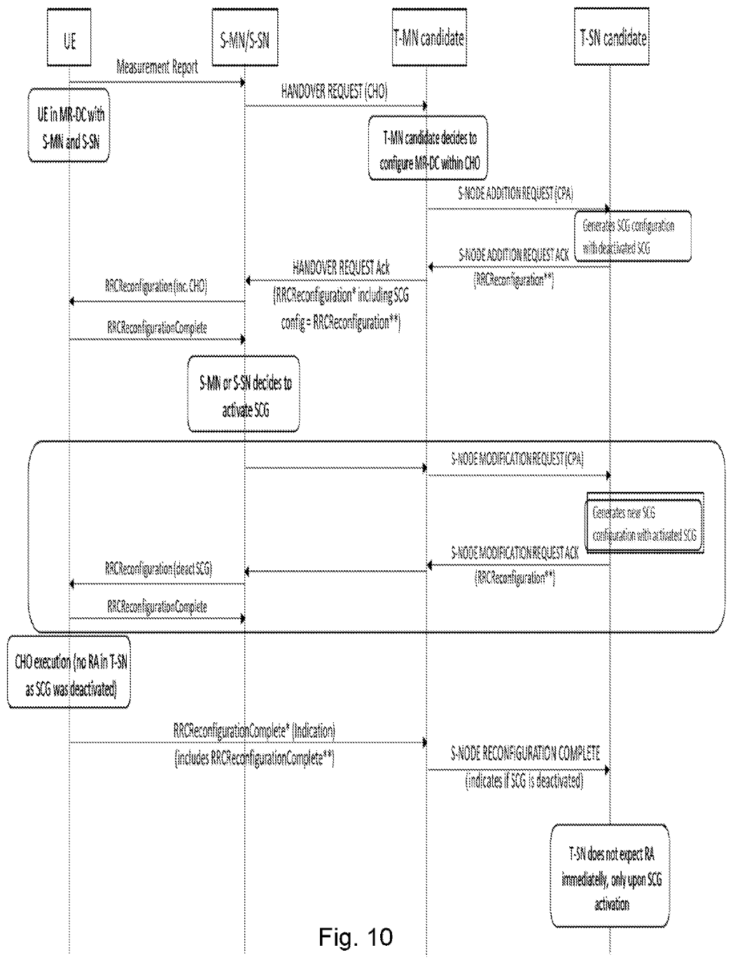

Methods herein may in some aspects be performed by the first network node 111, the second network node 112, and the third network node 113. As an alternative, a Distributed Node (DN) and functionality, e.g., comprised in a cloud 140 as shown in FIG. 10, may be used for performing or partly performing the methods.

Some example embodiments provide a method for the UE 120 to indicate an SCG state upon execution of CHO for a target candidate, wherein the target candidate includes an SCG configuration. The method includes in some embodiments, that the UE 120 indicates the current SCG state upon CHO execution, e.g., when UE 120 is configured with MR-DC while monitors CHO execution conditions, to the selected target candidate MN 112 and/or to the target candidate SN 113. At the network side, based on that indication, the target candidate MN 112 may trigger an MN-initiated SCG deactivation/activation, or the target candidate SN 113 may trigger an SN-initiated SCG deactivation/activation.

Some examples of the methods comprise that the UE 120 sets the SCG state of the SCG's target candidate to always deactivated. The logic would be to let the target candidate MN 112 and/or the target candidate SN 113 to react and activate the SCG after CHO execution depending on the traffic assessment after CHO execution.

Some examples of the methods comprise that the UE 120 sets the SCG state of the SCG's target candidate to always activated. The logic would be to let the target candidate MN 112 and/or the target candidate SN 113 to react and possibly deactivate the SCG after CHO execution depending on the traffic assessment after CHO execution. One benefit here is that this works even if target candidates don't support deactivated SCG.

Some examples of the methods comprise that the UE 120 sets the SCG state of the SCG's target candidate to a value pre-configured by the MN. E.g., activated or deactivated. The logic would be to let the target candidate MN 112 and/or the target candidate SN 113 to react and possibly deactivate the SCG after CHO execution depending on the traffic assessment after CHO execution. One benefit here is that this works even if target candidates don't support deactivated SCG.

Some examples of the methods comprise that the UE 120 sets the SCG state of the SCG's target candidate to the latest SCG state the UE 120 has when CHO executed.

Some examples of the methods comprise that the target candidate MN 112 informs a target candidate SN 113 about the current UE 120 SCG state upon CHO execution and/or for the UE 120 to determine the target candidate SCG state based on the current SCG state at the time of the CHO execution.

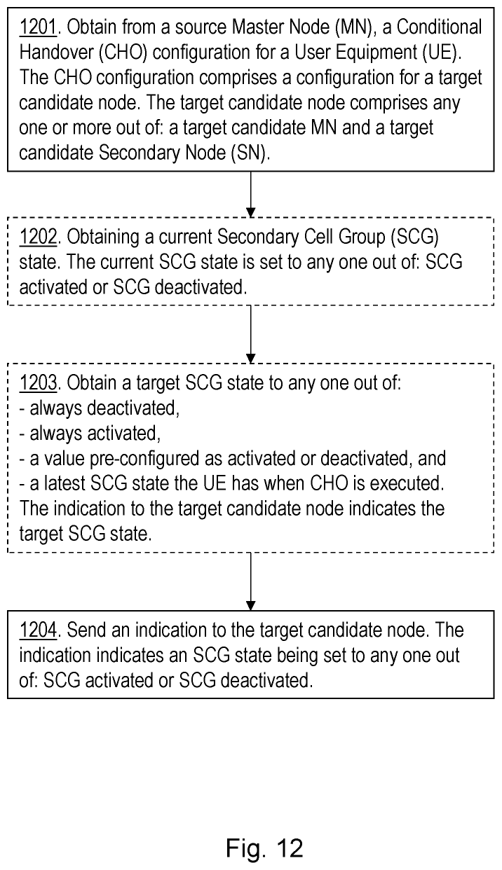

FIG. 12 shows an example method performed by the UE 120, or e.g., performed by a source MN 111. The UE 120 may also be referred to as a wireless device or a wireless terminal. The method is for indicating a SCG state during a CHO in the wireless communications network 100. The aim of this is to enable the UE 120 to determine which SCG is to be considered for the SCG configured which is to be applied upon CHO execution, wherein the target candidate configuration for CHO comprises an MR-DC configuration, including an SCG configuration. Thanks to that, upon CHO execution, the CHO configurations e.g., stored in the UE 120 do not have to be updated every time the SCG state changes in the source MN, while the UE 120 is still monitoring the CHO conditions. That may prevent a lot of signalling towards the UE 120, which represents less UE 120 energy consumption.

The UE 120 is configured with a current SCG, e.g., the UE 120 is configured with MR-DC. A current SCG when used herein, e.g., means the SCG the UE 120 is configured with when configured with MR-DC; i.e. that is the SCG and is currently used. The UE 120 is e.g., configured with MR-DC and is transmitting and/or receiving data from a MCG, MN, SCG and SN unless the current SCG is deactivated. The method may comprise any one or more out of the actions below. The following actions may be performed in any suitable order.

### Action 1201

The UE 120 obtains a CHO configuration for the UE 120 from the source MN 111. The CHO configuration comprises a configuration for a target candidate node 112, 113. It should be noted that the UE 120 obtains the configuration for the target candidate node 112, but the UE 120 may not be aware of what node the configuration belongs to.

A CHO configuration may e.g., comprise a target configuration for the UE 120, where the target configuration e.g., comprises both an MCG configuration and an SCG configuration. A configuration for an MN node may be an MCG configuration that the UE 120 sees and the configuration for an SN node is an SCG configuration.

The target candidate node 112, 113 may comprise any one or more out of the target candidate MN 112 and a target candidate SN 113. This means that the target candidate node 112, 113 e.g., may be the target candidate MN 112 or the target candidate SN 113.

### Action 1202

In some embodiments, the UE 120 obtains, such as e.g., receives, a current SCG state. The current SCG state may be set to any one out of: SCG activated or SCG deactivated. The current SCG state may be the SCG state that the UE 120 has when the CHO execution is started. The CHO execution may be towards the source SN. It should be noted that the source SN may be the same node as the target SN, e.g., since the same PSCell and/or SCG is kept at the CHO.

It should be noted that the wording “SCG activation” and “SCG deactivation” used herein is also referred to as “SCG activated” and “SCG deactivated”, since it is the state that is referred to and not the action.

### Action 1203

In some embodiments, the UE 120 obtains, e.g., by setting, a target SCG state to any one out of:
always deactivated,
always activated,
a value pre-configured, e.g., by the source MN 111, as activated or deactivated.
a latest SCG state the UE 120 has when CHO is executed, e.g., the current SCG state.

### Action 1204

The UE 120 sends an indication to the target candidate node 112, 113. The indication is sent when CHO execution conditions related to the CHO configuration are fulfilled. The indication indicates an SCG state being set to any one out of: SCG activated or SCG deactivated.

The SCG state that is indicated, may be set according to any one out of the current SCG state, and/or the target SCG state.

The indication may indicate a target SCG state to SCG activation or SCG deactivation, initiated by the selected target candidate node 112, 113, e.g., comprising any one or more out of: the target candidate MN 112 and/or the target candidate SN 113.

As an example, this may mean to set the SCG state towards the target SN 113, as part of applying the CHO configuration with SCG and that the UE 120 and the target network nodes 112, 113 then act accordingly.

The sending of the indication may in some embodiments comprise that the UE 120 performs a random access towards the target candidate node 112, 113, in order to indicate that the SCG is activated.

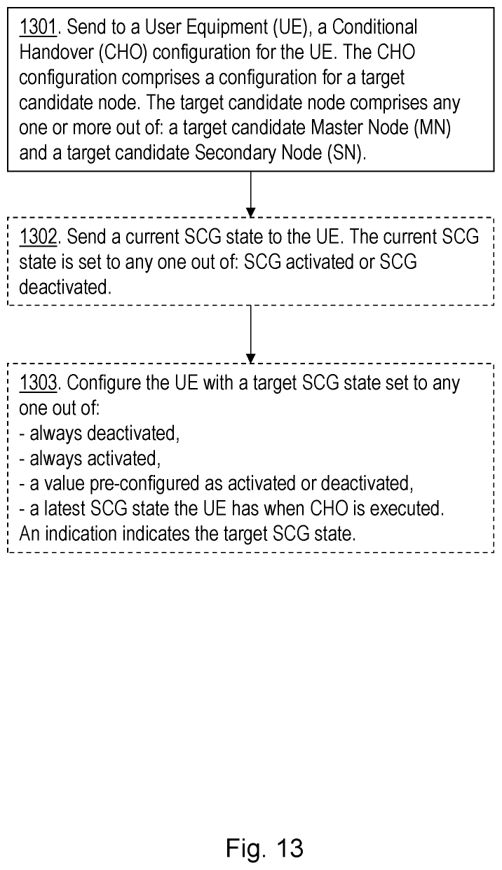

FIG. 13 shows an example method performed by the first network node 111 acting as a source MN 111. The method is for handling a SCG state during a CHO for the UE 120 in the wireless communications network 100. The UE 120 is configured with a current SCG.

The method may comprise any one or more out of the actions below. The following actions may be performed in any suitable order.

### Action 1301

The first network node 111 sends to the UE 120, a CHO configuration for the UE 120. The CHO configuration comprises a configuration for the target candidate node 112, 113. The target candidate node 112, 113 comprise any one or more out of: a target candidate MN 112 and a target candidate SN 113.

The CHO configuration triggers the UE 120 to, when CHO execution conditions relating to the CHO configuration are fulfilled, send an indication to the target candidate node 112, 113. The indication indicates an SCG state being set to any one out of: SCG activated or SCG deactivated. The SCG state may comprise any one out of the current SCG state, and/or a target SCG state.

### Action 1302

In some embodiments, the first network node 111 sends a current SCG state to the UE 120. The current SCG state may be set to any one out of: SCG activated or SCG deactivated.

In these embodiments, the indication to the target candidate node 112, 113 may indicate the current SCG state. The indication, e.g., as in action 1301, may in these embodiments set a target SCG state to SCG activation or SCG deactivation, initiated by the selected target candidate node 112, 113. The target candidate node 112, 113 may e.g., comprise any one or more out of: the target candidate MN 112 and/or the target candidate SN 113.

### Action 1303

In some embodiments, the first network node 111 may configure the UE 120 with a target SCG state set to any one out of:
always deactivated,
always activated,
a value pre-configured as activated or deactivated,
a latest SCG state the UE 120 has when CHO is executed.
The indication, e.g., as described in actions 1301-1302 above, may in in these embodiments indicate the target SCG state. This may mean that the MN 111 configures the UE 120 to send the current SCG state as target SCG state.

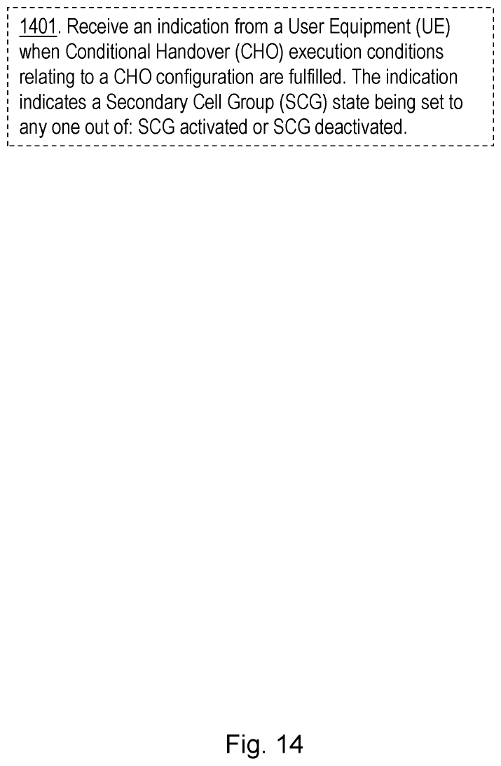

FIG. 14 shows an example method performed by the second network node 112 acting as a target MN 112. The method is for handling an SCG state during a CHO for the UE 120 in the wireless communications network 100. The UE 120 is configured with a current SCG.

The method may comprise any one or more out of the actions below. The following actions may be performed in any suitable order.

### Action 1401

The second network node 112 receives an indication from the UE 120 when CHO execution conditions relating to a CHO configuration are fulfilled. The indication may indicate an SCG state being set to any one out of: SCG activated or SCG deactivated.

The SCG state may comprise any one out of the current SCG state, and/or a target SCG state.

In some embodiments, e.g., when the indication indicates a current SCG state, the second network node 112 sets a target SCG state to SCG activation or SCG deactivation, based on the indication.

In some embodiments, e.g., when the indication indicates a target SCG state comprising deactivated, such as e.g., the target SCG state set to SCG deactivated, the second network node 112 reacts and e.g., possibly, activates the SCG after CHO execution depending on the traffic assessment after CHO execution.

In some embodiments, e.g., when the indication indicates a target SCG state comprising activated, such as e.g., the target SCG state set to SCG activated the second network node 112 reacts and possibly deactivates the SCG after CHO execution depending on the traffic assessment after CHO execution.

In some embodiments, e.g., when the indication indicates a target SCG state comprising a pre-configured value as activated or deactivated, such as e.g., the target SCG state set to a pre-configured value such as activated or deactivated, the second network node 112 reacts and possibly deactivates, or e.g., activates, the SCG after CHO execution depending on the traffic assessment after CHO execution.

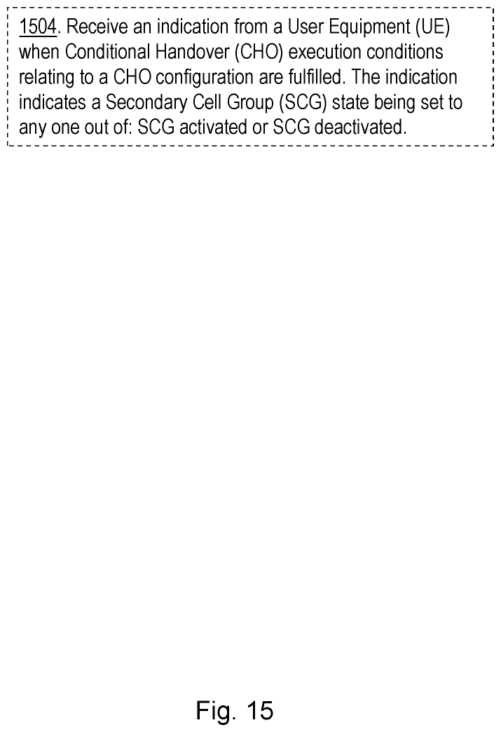

FIG. 15 shows an example method performed by the third network node 113 acting as a target SN 113. The method is for handling an SCG state during a CHO for the UE 120 in the wireless communications network 100. The UE 120 is configured with a current SCG. The method may comprise any one or more out of the actions below. The following actions may be performed in any suitable order.

### Action 1504

The third network node 113 receives an indication from the UE 120, e.g., when CHO execution conditions relating to a CHO configuration are fulfilled. The indication may indicate an SCG state being set to any one out of: SCG activated or SCG deactivated. The SCG state may comprise any one out of the current SCG state, and/or a target SCG state.

In some embodiments, e.g., when the indication indicates a current SCG state, the third network node 113 sets a target SCG state to SCG activation or SCG deactivation, based on the indication.

In some embodiments, e.g., when the indication indicates a target SCG state comprises deactivated, such as e.g., the target SCG state set to SCG deactivated, the third network node 113 reacts and e.g., possibly, activates the SCG after CHO execution depending on the traffic assessment after CHO execution.

In some embodiments, e.g., when the indication indicates a target SCG state comprises activated, such as e.g., the target SCG state set to SCG activated, the third network node 113 reacts and possibly deactivates the SCG after CHO execution depending on the traffic assessment after CHO execution,

In some embodiments, e.g., when the indication indicates a target SCG state comprises a pre-configured, value as activated or deactivated, such as e.g., the target SCG state set to a pre-configured value such as activated or deactivated, the third network node 113 reacts and possibly deactivates or e.g., activates the SCG after CHO execution depending on the traffic assessment after CHO execution.

Embodiments herein refer to the first network node 111 operating as a MN, e.g., a source MN, e.g., having a MCG configured to the UE 120 and/or an MN-terminated bearer; that MN can be a gNodeB, or a Central Unit gNodeB (CU-gNB) or an eNodeB, or a Central Unit eNodeB (CU-eNB), or any network node and/or network function. It should be noted that the wordings “first network node 111”, “source MN 111”, and “source MN” may be used interchangeably herein.

Embodiments herein refer to a second network node 112 operating as a MN, e.g., a target MN, e.g., having a MCG configured to the UE 120 and/or an MN-terminated bearer; that MN can be a gNodeB, or a Central Unit gNodeB (CU-gNB) or an eNodeB, or a CU-eNB, or any network node and/or network function. It should be noted that the wordings “second network node 112”, “target MN 112”, “target candidate MN” and “target MN” may be used interchangeably herein.

Embodiments herein also refer to a Secondary Node (SN) 110, or Source Secondary Node (S-SN) e.g., having a Secondary Cell Group (SCG) pre-configured (i.e. not connected to) to the UE 120; that SN can be a gNodeB, or a Central Unit gNodeB (CU-gNB) or an eNodeB, or a CU-eNB, or any network node and/or network function. Notice that MN, S-SN and T-SN may be from the same or different Radio Access Technologies, and possibly be associated to different Core Network nodes.

The text often refers to the third network node 113 operating as “Secondary Node (SN)”, target candidate SN 113 or target SN 113. This is equivalent to say this is a target candidate SN 113, or a network node associated to a target candidate PSCell that is being configured. If the UE 120 would connect to that cell, transmissions and receptions with the UE 120 would be handled by that node if the cell is associated to that node. It should be noted that the wordings “third network node 113”, “target SN 113”, “target candidate SN” and “target SN” may be used interchangeably herein.

The text says that a cell resides in a node e.g., a target candidate cell resides in the S-SN or the t-SN. That is equivalent to say that a cell is managed by the node, or is associated to the node, or associated with the node, or that the cell belongs to the node, or that the cell is of the node.

“SN-initiated CPC” corresponds to a procedure wherein the Source SN for a UE 120 configured with MR-DC determines to configure CPC. Upon determining the Source SN selects e.g., based on reported measurements, one or more target candidate cells (target candidate PSCell(s)) wherein at least one cell is associated to the Source SN, and at least another cell is associated to a neighbour SN. It can be said that if all target candidate cells are associated to the Source SN that is an “SN-initiated intra-SN CPC”, which may be referred as the Release 16 solution. It can be said that if at least one target candidate cell is associated to the neighbour SN that is an “SN-initiated inter-SN CPC”, which may be referred as a Release 17 solution.

The document refers to a candidate SN, or SN candidate, or an SN, as the network node (e.g., gNodeB) that is prepared during the CPA procedure and that can create an RRC Reconfiguration message with an SCG configuration (e.g., RRCReconfiguration**) to be provided to the UE 120 and stored, with an execution condition, wherein the UE 120 only applies the message upon the fulfillment of the execution condition. That candidate SN is associated to one or multiple PSCell candidate cell(s) that the UE 120 can be configured with. The ** used herein refers to an RRC Reconfiguration message with an SCG configuration, e.g., RRCReconfiguration**, to be provided to the UE 120 and stored, which may be applied by the UE 120 upon CHO execution. The UE 120 then may execute the condition and accesses one of these candidate cells, associated to a candidate SN that becomes the SN or simply the SN after execution (i.e. upon fulfillment of the execution condition).

The document refers to a CPC configuration and procedures, like CPC execution, most of the time to refer to the procedure from the UE 120 perspective. Other terms may be considered as synonyms such as conditional reconfiguration, or Conditional Configuration, since the message that is stored and applied upon fulfillment of a condition is an RRCReconfiguration or RRCConnectionReconfiguration. Terminology wise, one may also interpret CHO in a broader sense, also covering CPA (Conditional PSCell Change) procedures. The document refers to a Conditional SN Change most of the time to refer to the procedure from the UE 120 perspective, to refer to procedures between network nodes wherein a node requests a target candidate SN 113 (which may be the same as the Source SN or a neighbour SN) to configure a CPC for at least one of its associated cells (cell associated to the target candidate SN 113).

The document refers to CPAC as a way to refer to either a Conditional PSCell Addition (CPA) or a CPC.

The document refers to a neighbour SN and a Source SN as different entities, though both may be a target candidate SN 113 for CPC.

The configuration of CPC can be done using the same IEs as conditional handover, which may be called at some point conditional configuration or conditional reconfiguration. The principle for the configuration is the same with configuring triggering/execution condition(s) and a reconfiguration message to be applied when the triggering condition(s) are fulfilled. The configuration IEs from 3GPP TS 38.331:

### ConditionalReconfiguration

The IE ConditionalReconfiguration is used to add, modify and release the configuration of conditional configuration.

ConditionalReconfiguration information element

-- ASN1START
-- TAG-CONDITIONALRECONFIGURATION-START

| ConditionalReconfiguration-r16 ::= | SEQUENCE { | |
|---|---|---|
| attemptCcondReconfiq-r16 | ENUMERATED {true} | OPTIONAL, -- Need N |
| condConfigToRemoveList-r16 | CondConfigToRemoveList-r16 | OPTIONAL, -- Need N |
| condConfigToAddModList-r16 | CondConfigToAddModList-r16 | OPTIONAL, -- Need N |

...
}

| | |
|---|---|
| CondConfigToRemoveList-r16 ::= | SEQUENCE (SIZE (1.. maxNrofCondCells)) OF CondConfigId-r16 |

-- TAG-CONDITIONALRECONFIGURATION-STOP
-- ASN1STOP

ConditionalReconfiguration field descriptions

condConfigToAddModList
List of the configuration of candidate SpCells to be added or modified
for CHO or CPC.
condConfigToRemoveList
List of the configuration of candidate SpCells to be removed. When the
network removes the stored conditional configuration for a candidate
cell, the network releases the measIDs associated to the
condExecutionCond if it is not used by the condExecutionCond of other
candidate cells.

### CondConfigId

The IE CondConfigId is used to identify a CHO or CPC configuration.

CondConfigId information element

| -- ASN1START | |
|---|---|
| -- TAG-CONDCONFIGID-START | |
| CondConfigId-r16 ::= | INTEGER (1.. maxNrofCond-Cells) |

-- TAG-CONDCONFIGID-STOP
-- ASN1STOP

### CondConfig ToAddModList

The IE CHO-ConfigToAddModList concerns a list of conditional configurations to add or modify, with for each entry the cho-ConfigId and the associated condExecutionCond and condRRCReconfig.

CondConfigToAddModList information element

-- ASN1START
-- TAG-CONDCONFIGTOADDMODLIST-START

| | |
|---|---|
| CondConfigToAddModList-r16 ::= | SEQUENCE (SIZE (1.. maxNrofCondCells)) OF |

CondConfigToAddMod-r16

| | |
|---|---|
| CondConfigToAddMod-r16 ::= | SEQUENCE { |
| condConfigId-r16 | CondConfigId-r16, |
| condExecutionCond-r16 | SEQUENCE (SIZE (1..2)) OF MeasId |

OPTIONAL, -- Need S

| | |
|---|---|
| condRRCReconfig-r16 | OCTET STRING (CONTAINING |

RRCReconfiguration) OPTIONAL, -- Need S
...
}
-- TAG-CONDCONFIGTOADDMODLIST-STOP
-- ASN1STOP

CondConfigToAddMod field descriptions

condExecutionCond
The execution condition that needs to be fulfilled in order to trigger the
execution of a conditional configuration. The field is mandatory present
when a condConfigId is being added. Otherwise, when the
condRRCReconfig associated to a condConfigId is being modified it is
optionally present and the UE 120 uses the stored value if the field
is absent.
condRRCReconfig
The RRCReconfiguration message to be applied when the condition(s) are
fulfilled. The field is mandatory present when a condConfigId is being
added. Otherwise, when the condExecutionCond associated to a
condConfigId is being modified it is optionally present and the UE 120
uses the stored value if the field is absent.

In the different embodiments these IEs are used differently e.g., sometimes generated by the MN 111, sometimes generated by the source SN, sometimes by a target candidate SN 113.

In the different embodiments it is said the CPC is in MN format when the CPC configuration is not configured as an MR-DC configuration in mrdc-SecondaryCellGroup (as defined in 3GPP TS 38.331). In other words, the UE 120 receives an RRCReconfiguration from the MN that may contain the mrdc-SecondaryCellGroup (e.g., in case the UE 120 is also configured with an SCG MeasConfig for inter-SN CPC) but the CPC is not within that container. That means the IEs listed above (e.g., the IE ConditionalReconfiguration) are not included in mrdc-SecondaryCellGroup.

In the different embodiments it is said the CPC is in SN format when the CPC configuration is configured as an MR-DC configuration in mrdc-SecondaryCellGroup (as defined in 3GPP TS 38.331). In other words, the UE 120 receives an RRCReconfiguration from the MN that may contain the mrdc-SecondaryCellGroup and the CPC is within that container. That means the IEs listed above (e.g., the IE ConditionalReconfiguration) are included in mrdc-SecondaryCellGroup (e.g., within a series of other nested IEs).

The text often refers to a “Secondary Node (SN)”, or target SN 113. This is equivalent to say this is a target candidate SN 113, or a network node associated to a target candidate PSCell that is being configured.

Below, some example embodiments will be described.

Examples A0. Some embodiments comprise a method at a wireless terminal, e.g., the UE 120 or by the source MN 111, for a UE 120 configured with MR-DC, with a current SCG, the method comprising:
Receiving a CHO configuration including a configuration for a target candidate cell, wherein the configuration is to be applied by the UE 120 upon fulfillment of an execution condition that the UE 120 monitors upon reception of the CHO configuration; and
Receiving at least one indication for the SCG state of the current SCG, and setting the SCG state of the current SCG to SCG deactivate or SCG activated based on the indication; and
Selecting a target candidate cell, e.g., provided by any one of the target MN 112 or the target SN 113, upon the fulfillment the execution condition and applying the configuration for selected target candidate cell; and
Upon applying the configuration for the target candidate cell, such as e.g., for any one out of: the target MN 112 or the target SN 113, transmitting an RRC Reconfiguration Complete message (RRCReconfigurationComplete) to the selected target candidate cell and performing at least one of the following actions related to an SCG state, e.g., an SCG state indicated in the message, (or a combination of them):
   Include in the RRC Reconfiguration Complete an indication of the latest state of the current SCG;
   If the configuration for the target candidate includes an SCG configuration, consider the SCG state of the target candidate to be the latest state of the current SCG, and perform actions accordingly e.g., if latest state of the current SCG is activated, perform random access to the target candidate PSCell;
   If the configuration for the target candidate includes an SCG configuration, consider the SCG state of the target candidate always to be activated, regardless of what the state of the current SCG is, and perform actions accordingly such as perform random access to the target candidate PSCell;
   If the configuration for the target candidate includes an SCG configuration, consider the SCG state of the target candidate always to be deactivated, regardless of what the state of the current SCG is, and perform actions accordingly;
   If the configuration for the target candidate includes an SCG configuration, consider the SCG state of the target candidate to be the state set in the SCG configuration, regardless of what the state of the current SCG is, and perform actions accordingly.

Example A0b. An example according to example A0, the UE 120 performing at least one of the actions related to an SCG state if the configuration for a target candidate cell the UE 120 applies includes an SCG configuration.

Example A1. An example according to example A0, wherein the UE 120 ignores an included SCG state information or configuration in the target candidate SCG configuration when determining the SCG state of the selected target candidate SCG.

Example A2. An example according to example A0, wherein the UE 120 receives the one or more indications for the SCG state of the current SCG before the UE 120 receives the CHO MR-DC configuration, or after the UE 120 receives the CHO MR-DC configuration and/or while the UE 120 is monitoring CHO execution conditions.

Example A3. An example according to example A0, wherein the SCG state of the current SCG is the SCG state indicated by the latest received indication of the SCG state before the UE 120 has applied the selected target candidate SCG.

Example A4. An example according to example A0, wherein the RRC Reconfiguration Complete is an MN RRC Reconfiguration Complete triggered in response to the UE 120 applying an MCG configuration.

Example A5. An example according to example A0, wherein the RRC Reconfiguration Complete is an SN RRC Reconfiguration Complete included within an MN RRC Reconfiguration Complete, wherein the SN RRC Reconfiguration Complete is triggered in response to the UE 120 applying an SCG configuration.

Example A20. Some embodiments comprise a method at a first network node 111 operating as a Master Node (MN) for a UE 120 configured with MR-DC, wherein the UE 120 is configured with a current SCG, and CHO, the method comprising:
Transmitting to the UE 120 a CHO configuration comprising one or multiple target candidate SCG configuration(s) wherein each target candidate SCG configuration and MCG configuration are to be applied by the UE 120 upon fulfillment of an execution condition that the UE 120 monitors upon reception of the CHO configuration; and
Transmitting one or more indications for the SCG state of the current SCG, wherein the SCG state of the current SCG may be set to SCG deactivate or SCG activated; and

A method at a second network node operating as a Master Node (MN), e.g., the MN 112, the method comprising:
Receiving from the UE 120 an RRCReconfigurationComplete message, also possibly containing an RRCReconfigurationComplete** to the SN, indicating that the UE 120 has executed CHO, wherein the UE 120 transmits the message upon applying the target candidate MCG and SCG configuration of the selected target candidate.
Forwarding a Reconfiguration Complete message to a third network node operating as the target candidate SN 113 for the selected target candidate SCG, and an indication of the determined SCG state of the selected target candidate SCG.

Example A21. An example according to example A20, wherein the first network node 111 operating as the MN for the UE 120 determines to configure the UE 120 with CHO with MR-DC configuration and trigger a request to a second network node requesting MR-DC configuration for the UE 120 i.e. one or multiple target candidate SCG configuration(s).

Example A22. An example according to example A20, wherein the one or more indications for the SCG state of the current SCG may have been determined by the source MN 111 or by the source SN, based on traffic demands at the MN and/or the SN.

Example A30. Some embodiments comprise a method at a third network node 113 operating as a candidate Secondary Node (SN) for a UE 120 configured with MR-DC, wherein the UE 120 is configured with a current Secondary Cell Group (SCG), and with CHO containing an MR-DC configuration and having the possibility to set the SCG state to be deactivated or activated, the method comprising:
Receiving a request for CHO from a target candidate MN 112, generating one or more target candidate PSCell configurations for CHO with MR-DC and transmitting these one or more target candidate PSCell configurations to a target candidate MN 112, wherein the UE 120 is to apply one of the configurations upon fulfillment of one execution condition that the UE 120 monitors upon reception of the CHO configuration; and
Receiving from the target candidate MN 112 a Reconfiguration Complete message for the selected target candidate SCG, and an indication of the determined SCG state of the selected target candidate SCG.
Performing actions towards the UE 120 according to the indicated SCG state of the selected target candidate SCG.

Example A40. Some embodiments comprise a method at a second network node 112 operating as a Master Node (MN) target candidate for a UE 120 configured with Conditional Handover, the method comprising:
Receiving a Handover Request for a conditional handover from a first network node 111 operating as Master Node for a UE 120 configured with MR-DC, with at least one SCG;
Transmitting a Handover Request Acknowledgement message including a configuration for a target candidate cell, wherein the configuration is to be applied by the UE 120 upon fulfillment of an execution condition that the UE 120 monitors upon reception of the CHO configuration; and
Receiving an RRC reconfiguration complete from the UE 120, and performing at least one of the following actions:
   Further receiving in the RRC reconfiguration complete message an indication of the latest SCG state the UE 120 has with the source SCG, and consider the UE 120 to operate in the target's SCG according to that indicated state;
   If the configuration for the target candidate included an SCG configuration, consider the SCG state of the target candidate to be the latest state of the current SCG, and perform actions accordingly e.g., if latest state of the current SCG is activated, perform random access to the target candidate PSCell;
   If the configuration for the target candidate included an SCG configuration, consider the SCG state of the target candidate always to be activated, regardless of what the state of the current SCG is, and perform actions accordingly such as perform random access with the UE 120 and the target candidate PSCell e.g., responds UE 120's random access request/preamble;
   If the configuration for the target candidate included an SCG configuration, consider the SCG state of the target candidate always to be deactivated, regardless of what the state of the current SCG is, and perform actions accordingly;
   If the configuration for the target candidate included an SCG configuration, consider the SCG state of the target candidate to be the state set in the SCG configuration, regardless of what the state of the current SCG is, and perform actions accordingly.
   Possibly indicate the target candidate SN 113 the SCG state to be applied for the incoming UE 120.

### Some Further Embodiments

Indication of SCG Deactivation Upon CHO with MR-DC

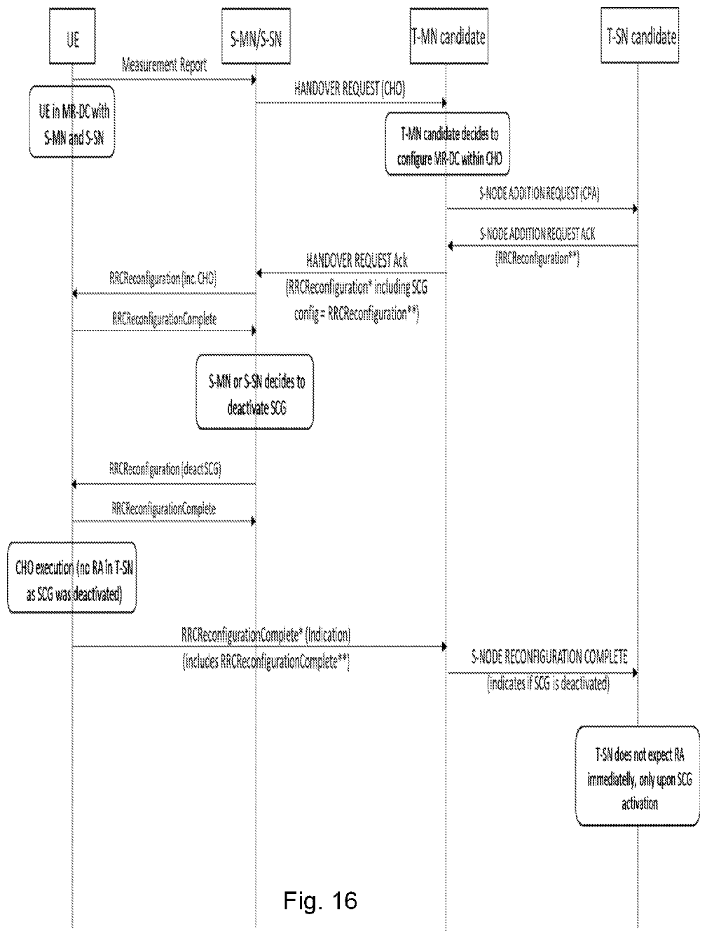

Indication of SCG deactivation upon CHO with MR-DC (related to example set A) is illustrated in FIG. 16.

In a set of embodiments Some embodiments comprise a method executed by the UE 120 or e.g., the source MN 111. This is related to and may be merged into the method performed by the UE 120 or e.g., the source MN 111 described above. The method comprising:
Possibly having an MR-DC configuration and the SCG state possibly being set to activated or deactivated;
Receiving, from the network a CHO configuration containing an MR-DC configuration, which may correspond to an RRCReconfiguration message containing configuration of CHO with MR-DC in the target configuration, wherein the CHO configuration is to be applied when the condition(s) are fulfilled (wherein the SCG message to be applied can be denoted RRCReconfiguration**).
   In some embodiments the message contains an indication that the UE 120 should continue using the same SCG state as it has when the condition is fulfilled and the new target configuration is applied. In other words, if the UE 120 has the current SCG deactivated at the time the UE 120 executes CHO with MR-DC, the UE 120 selects a target configuration, applies the SCG configuration for the selected target candidate and considers the SCG state of the target candidate SCG being applied as deactivated;
   In some embodiments the CHO configuration also comprises measurement configurations for the SCG, such as an SCG MeasConfig including the reporting configuration for configuring the event(s) for the execution condition(s) and/or the measurement object associated to the frequencies (e.g., SSB frequencies, SSB ARFCNs) of the target candidate PSCells, and the measurement identities to be referred in the CHO configuration for the target candidate(s).
Transmitting, to the network, an RRCReconfigurationComplete in response to that CHO with MR-DC was configured;
Receiving an indication (e.g., RRCReconfiguration message) from the network (e.g., from the network node operating as the MN or the network node operating as the SN) indicating an SCG state (mode of operation) and/or as change in the SCG state (mode of operation).
   For example, if the state was activated, this may be an indication to change it to deactivated or, if the state was deactivated, this may be an indication to change it to activated;
   While the UE 120 is configured with CHO with MR-DC and is monitoring the execution conditions for CHO with MR-DC the UE 120 may receive one or multiple indications for setting the SCG state.
   In some embodiments, the UE 120 receives the indication before it has been configured with CHO with MR-DC i.e. when the UE 120 is configured with CHO the UE 120 had already received the SCG state indication.
   In some embodiments, the UE 120 receives the indication after it has been configured with CHO with MR-DC.
   In some embodiments, the UE 120 receives the indication upon it has been configured with CHO with MR-DC i.e. in the same message the UE 120 is configured with CHO with MR-DC the UE 120 also receives the indication of the SCG state.
   This may be one or more indications for the SCG state of the current SCG, wherein the SCG state of the current SCG may be set to SCG deactivated or SCG activated; The current SCG is the SCG configured at the UE 120 at the moment the UE 120 receives the CHO with MR-DC configuration.
   The indication may be an indication in an MCG configuration, or an SCG configuration (e.g., generated by the network node operating as the SN).
Selecting a target candidate upon the fulfillment the execution condition, applying the target candidate configuration containing the selected target candidate MCG and SCG configuration; and
Determining the SCG state of the selected target candidate SCG to be the same SCG state of the current SCG;
   In some embodiments this may be realized by delta signaling. The target candidate SN 113 that is capable of the SCG deactivation feature may indicate that in a flag to the UE 120, so that the UE 120 is allowed to set the SCG to deactivate if the current SCG is deactivated upon the fulfillment of the execution condition(s). The delta signaling aspect is basically that the target candidate SN 113 does Not include an indication of deactivated SCG, and its absence means that the UE 120 considers the target candidate SCG state as the SCG state of the current SCG at the moment the UE 120 executes CPC.
Upon applying the target candidate SCG configuration of the selected target candidate SCG (the target SCG may be the same as the source SCG), transmitting an RRCReconfigurationComplete to a first network node and performing further actions according to that determined SCG state of the selected target candidate SCG.
   In some embodiments, transmitting an RRC Reconfiguration Complete corresponds to transmitting an RRCReconfigurationComplete containing a RRCReconfigurationComplete** indicating that the condition(s) in the UE 120 were fulfilled and that the UE 120 has applied the target configuration, wherein the RRCReconfigurationComplete** is forwarded from the MN to the SN. The UE 120 is still using the same SCG state as it had before the message RRCReconfiguration** was applied;
   In some embodiments the RRC Reconfiguration Complete (e.g., the RRCReconfigurationComplete**) also includes an indication of the SCG state of the selected SCG, which is the same state and the SCG the UE 120 was configured with when it has executed CHO. One advantage of this embodiment is that the MN does not need to bother about indicating the SCG state to the target candidate SN 113 via XnAP information, as that is considered to be contained within the RRCReconfigurationComplete**.
   In some embodiments the RRC Reconfiguration Complete (e.g., the RRCeconfigurationComplete**) also includes an indication of the SCG state of the selected SCG suggested/requested by the UE 120;
   In some embodiments, start operating according to the SCG state the UE 120 had before the RRCReconfigurationComplete containing a, to the T-SN, RRCReconfigurationComplete** indicating that the condition(s) in the UE 120 were fulfilled and that the UE 120 has applied the target configuration and executed a PSCell Change. The UE 120 is still using the same SCG state as it had before the message RRCReconfiguration** was applied;
   In some embodiments, if the determined SCG state is to be activated, upon determining the state the UE 120 trigger a random access to the selected target SCG.
   In some embodiments, if the determined SCG state is to be deactivated, upon determining the state the UE 120 does not trigger a random access to the selected target SCG.
   In some embodiments, if the determined SCG state is to be deactivated, upon determining the state the UE 120 trigger a random access to the selected target SCG only if explicitly indicated by the network e.g., in case the network wants to have the UE 120 prepared for a faster activation later on. In other words, even though the SCG has been changed to an SCG that is deactivated, by doing random access the UE 120 is prepared to quickly activate the SCG afterwards.
   In some embodiments, the UE 120 receives a target candidate SCG configuration (as part of the CHO with MR-DC configuration) that includes configuration that is specific to the SCG state. As an example, some of the configuration is only applicable if the SCG state is determined as to be activated. In one example, some of the configuration is only applicable if the SCG state is determined as to be deactivated. When the UE 120 applies the CHO with MR-DC configuration, it then applies the SCG configuration that is related to the determined SCG state and starts operating according to that configuration. In one alternative, the UE 120 may apply the received configuration for both (or all) SCG states, e.g., both for SCG activated and for SCG deactivated, but start operating according to the configuration for determined state. As an example, if the determined SCG state is deactivated, the UE 120 would then start operating according to the configuration for SCG deactivated, but not according to the configuration that is specific for SCG activated, but it would store the configuration also for SCG activated. If the SCG state then is changed to SCG activated, the UE 120 would then instead start operating according to the stored configuration for SCG activated (but not according to the configuration that is specific for SCG deactivated).
   In some embodiments, the UE 120 receives an MCG configuration (as part of the CHO with MR-DC configuration) that includes configuration that is specific to the SCG state (i.e. where parts of the configuration is only applicable if the SCG state is determined as to be activated and/or other parts of the configuration is only applicable if the SCG state is determined as to be deactivated). When the UE 120 applies the CHO with MR-DC configuration, it then applies the MCG configuration that is related to the determined SCG state and starts operating according to that configuration.

Some embodiments comprise a method executed by the source MN 111. This is related to and may be merged into the method performed by the first network node 111 described above. The method comprising:
Transmitting a message to the target candidate Master Node (MN) 112, the message requesting configuration of CHO with MR-DC configuration. The message comprises the UE 120 current configuration, indicating that the UE 120 is configured with or is capable of deactivated SCG;
   In some embodiments the message being a HANDOVER REQUEST message;
   In some embodiments the current SCG configuration included in the SN configuration in HandoverPreparationInformation;
   In some embodiments the message includes the current SCG state of UE 120 e.g., activated SCG, deactivated SCG, which may be considered as part of the UE 120 configuration;
Receiving a message from the target candidate MN 112, the message containing the CHO with MR-DC configuration, comprising one or multiple target candidate MCG and SCG configuration(s) wherein each target candidate MCG and SCG configuration is to be applied by the UE 120 upon fulfillment of an execution condition that the UE 120 monitors upon reception of the CPC configuration, and wherein each target candidate SCG configuration is within an SCG RRC Reconfiguration message denoted RRCReconfiguration**;
   In some embodiments the message is an HANDOVER REQUEST ACKNOWLEDGE message;
   In some embodiments the message contains an indication that the UE 120 is allowed to (and/or shall) continue using the same SCG state as it has when the condition(s) are fulfilled and the target configuration RRCReconfiguration** is applied; the indication may be the absence of a parameter whose its presence would have indicated an SCG deactivation; the indication may be the absence of a parameter whose its presence would have indicated an SCG deactivation and a second parameter indicating that the UE 120 may (and/or shall) continue using the current SCG state in the newly SCG being applied.
   In some embodiments the UE 120 target configuration RRCReconfiguration** does not contain information about which SCG state to use;
Transmitting, to the UE 120, an RRCReconfiguration message comprising a configuration of CHO with MR-DC;
Receiving, from the UE 120, an RRCReconfigurationComplete indicating that CHO with MR-DC was configured;
Change the SCG state of the UE 120 by e.g., transmitting an RRCReconfiguration message with the new SCG state to the UE 120. If the state was activated, change to deactivated. If the state was deactivated, change to activated;
Receiving a response message, from the UE 120, RRCReconfigurationComplete indicating that the SCG state was changed.

Some embodiments comprise a method executed by the target MN 112. This is related to and may be merged into the method performed by the second network node 112 described above. The method comprising:
Transmitting a message to the target candidate SN 113, the message requesting configuration of CHO with MR-DC configuration. The message containing the UE 120 current configuration, indicating that the UE 120 is configured with or is capable of deactivated SCG;
   In some embodiments the message being an S-NODE ADDITION REQUEST message;
   In some embodiments the current SCG configuration included in the target SN 113 configuration in CG-ConfigInfo;
   In some embodiments the message includes the current SCG state of UE 120 e.g., activated SCG, deactivated SCG, which may be considered as part of the UE 120 configuration;
   In some embodiments, the target MN 112 determines to configure the UE 120 with MR-DC in the CHO configuration.
Receiving a message from a target candidate Secondary Node (SN), the message containing the SCG configuration, comprising one or multiple target candidate SCG configuration(s) wherein each target candidate SCG configuration is to be applied by the UE 120 upon fulfillment of an execution condition that the UE 120 monitors upon reception of the CHO configuration, and wherein each target candidate SCG configuration is within an SCG RRC Reconfiguration message denoted RRCReconfiguration**;
   In some embodiments the message is an S-NODE ADDITION REQUEST ACK message;
   In some embodiments the message contains an indication that the UE 120 is allowed to (and/or shall) continue using the same SCG state as it has when the condition(s) are fulfilled and the target configuration RRCReconfiguration** is applied; the indication may be the absence of a parameter which presence would have indicated an SCG deactivation; the indication may be the absence of a parameter which presence would have indicated an SCG deactivation and a second parameter indicating that the UE 120 may (and/or shall) continue using the current SCG state in the newly SCG being applied.
   In some embodiments the UE 120 target configuration RRCReconfiguration** does not contain information about which SCG state to use;
Transmitting a response message, e.g., HANDOVER REQUEST-ACKNOWLEDGE, to the source MN that CHO with MR-DC has been configured;
Receiving a message from the UE 120, an RRCReconfigurationComplete containing a RRCReconfigurationComplete** to the T-SN, indicating that the condition(s) in the UE 120 were fulfilled and that the UE 120 has applied the target configuration and CHO containing an MR-DC configuration;
Forwarding, to the T-SN, the RRCReconfigurationComplete** message, the message containing an indication of the current SCG state of the UE 120; Some embodiments comprise a method executed by a target Secondary Node (SN) candidate the method comprising:
Receiving a message from a target Master Node (MN), the message requesting configuration of an SCG for a CHO with MR-DC configuration. The message containing the UE 120 current configuration, indicating that the UE 120 is configured with or is capable of deactivated SCG;
   The message being an S-NODE ADDITION REQUEST message;
   The current SCG configuration included in the target SN 113 configuration in
Transmitting a message to a Master Node (MN), the message containing RRCReconfiguration** with the UE 120 target configuration;
   The message being an S-NODE ADDITION REQUEST ACK message;
   The message containing an indication that the UE 120 is allowed to continue using the same SCG state as it has when the condition(s) are fulfilled and the target configuration RRCReconfiguration** is applied;
   The UE 120 target configuration RRCReconfiguration** not containing information about which SCG state to use;
Receiving, from the MN, the RRCReconfigurationComplete** message, the message containing an indication from the UE 120 regarding the current SCG state;
   Not immediately expecting Random Access from the UE 120 in case the SCG state is currently deactivated;
Deciding to keep or change the current SCG state;

In some embodiments, the target Secondary Node (SN) 113 includes a configuration that is specific to a specific SCG state within the RRCReconfiguration** with the UE 120 target configuration. For example, the UE 120 target configuration may include some configuration that is specific to the case where the SCG state is activated and it may include some configuration that is specific to the case where the SCG state is deactivated.

### The UE 120 Always Setting the SCG State of the SCG's Target Candidate to Deactivated

In a set of embodiments some of them comprise a method executed by the UE 120 or e.g., the source MN 111. This is related to and may be merged into the method performed by the UE 120 or e.g., the source MN 111 described above. The method comprising:
Possibly having an MR-DC configuration and the SCG state possibly being set to activated or deactivated;
Receiving, from the network a CHO configuration containing an MR-DC configuration, which may correspond to an RRCReconfiguration message containing configuration of CHO with MR-DC in the target configuration, wherein the CHO configuration is to be applied when the condition(s) are fulfilled (wherein the SCG message to be applied may be denoted RRCReconfiguration**).
   In some embodiments the CHO configuration also comprises measurement configurations for the SCG, such as an SCG MeasConfig including the reporting configuration for configuring the event(s) for the execution condition(s) and/or the measurement object associated to the frequencies (e.g., SSB frequencies, SSB ARFCNs) of the target candidate PSCells, and the measurement identities to be referred in the CHO configuration for the target candidate(s).
Transmitting, to the network, an RRCReconfigurationComplete in response to that CHO with MR-DC was configured;
Receiving an indication (e.g., RRCReconfiguration message) from the network (e.g., from the network node operating as the MN 111 or the network node operating as the SN 110) indicating an SCG state (mode of operation) and/or as change in the SCG state (mode of operation).
   For example, if the state was activated, this may be an indication to change it to deactivated or, if the state was deactivated, this may be an indication to change it to activated;
   While the UE 120 is configured with CHO with MR-DC and is monitoring the execution conditions for CHO with MR-DC the UE 120 may receive one or multiple indications for setting the SCG state.
   In some embodiments, the UE 120 receives the indication before it has been configured with CHO with MR-DC i.e. when the UE 120 is configured with CHO the UE 120 had already received the SCG state indication.
   In some embodiments, the UE 120 receives the indication after it has been configured with CHO with MR-DC.
   In some embodiments, the UE 120 receives the indication upon it has been configured with CHO with MR-DC i.e. in the same message the UE 120 is configured with CHO with MR-DC the UE 120 also receives the indication of the SCG state.
   This may be one or more indications for the SCG state of the current SCG, wherein the SCG state of the current SCG may be set to SCG deactivated or SCG activated; The current SCG is the SCG configured at the UE 120 at the moment the UE 120 receives the CHO with MR-DC configuration.
   The indication may be an indication in an MCG configuration, or an SCG configuration (e.g., generated by the network node operating as the SN).
Selecting a target candidate upon the fulfillment the execution condition, applying the target candidate configuration containing the selected target candidate MCG and SCG configuration; and
Setting the SCG state of the selected target candidate SCG to be deactivated;
Upon applying the target candidate SCG configuration of the selected target candidate SCG (the target SCG may be the same as the source SCG), transmitting an RRCReconfigurationComplete to a first network node and performing further actions according to the SCG state of the selected target candidate SCG.
   In some embodiments, transmitting an RRC Reconfiguration Complete corresponds to transmitting an RRCReconfigurationComplete containing a RRCReconfigurationComplete** indicating that the condition(s) in the UE 120 were fulfilled and that the UE 120 has applied the target configuration, wherein the RRCReconfigurationComplete** is forwarded from the MN to the SN; The UE 120 is using the SCG state deactivated;
   In some embodiments, upon determining the state the UE 120 does not trigger a random access to the selected target SCG.
   In some embodiments, upon determining the state the UE 120 trigger a random access to the selected target SCG only if explicitly indicated by the network e.g., in case the network wants to have the UE 120 prepared for a faster activation later on. In other words, even though the SCG has been changed to an SCG that is deactivated, by doing random access the UE 120 is prepared to quickly activate the SCG afterwards.

In one set of embodiments, some embodiments comprise a method executed by the source MN 111. This is related to and may be merged into the method performed by the first network node 111 described above. The method comprising:
Transmitting a message to the target candidate MN 112, the message requesting configuration of CHO with MR-DC configuration. The message containing the UE 120 current configuration, indicating that the UE 120 is configured with or is capable of deactivated SCG;
   In some embodiments the message being a HANDOVER REQUEST message;
   In some embodiments the current SCG configuration included in the SN configuration in HandoverPreparationInformation;
   In some embodiments the message includes the current SCG state of UE 120 e.g., activated SCG, deactivated SCG, which may be considered as part of the UE 120 configuration;
Receiving a message from a target candidate MN 112, the message containing the CHO with MR-DC configuration, comprising one or multiple target candidate MCG and SCG configuration(s) wherein each target candidate MCG and SCG configuration is to be applied by the UE 120 upon fulfillment of an execution condition that the UE 120 monitors upon reception of the CPC configuration, and wherein each target candidate SCG configuration is within an SCG RRC Reconfiguration message denoted RRCReconfiguration**;
   In some embodiments the message is a HANDOVER REQUEST ACKNOWLEDGE message;
   In some embodiments the UE 120 should always set the SCG state to deactivated when the condition(s) are fulfilled and the target configuration RRCReconfiguration** is applied;
   In some embodiments the UE 120 target configuration RRCReconfiguration** does not contain information about which SCG state to use;
Transmitting, to the UE 120, an RRCReconfiguration message containing configuration of CHO with MR-DC;
Receiving, from the UE 120, an RRCReconfigurationComplete indicating that CHO with MR-DC was configured.

Some embodiments comprise a method executed by the target MN 112. This is related to and may be merged into the method performed by the second network node 112 described above. The method comprising:
Transmitting a message to thea target candidate SN 113, the message requesting configuration of CHO with MR-DC configuration. The message containing the UE 120 current configuration, indicating that the UE 120 is configured with or is capable of deactivated SCG;
   In some embodiments the message being an S-NODE ADDITION REQUEST message;
   In some embodiments the current SCG configuration included in the target SN 113 configuration in CG-ConfigInfo;
   In some embodiments the message includes the current SCG state of UE 120 e.g., activated SCG, deactivated SCG;
   In some embodiments, the target MN 112 determines to configure the UE 120 with MR-DC in the CHO configuration.
Receiving a message from the target candidate SN 113, the message containing the SCG configuration, comprising one or multiple target candidate SCG configuration(s) wherein each target candidate SCG configuration is to be applied by the UE 120 upon fulfillment of an execution condition that the UE 120 monitors upon reception of the CHO configuration, and wherein each target candidate SCG configuration is within an SCG RRC Reconfiguration message denoted RRCReconfiguration**;
   In some embodiments the message is an S-NODE ADDITION REQUEST ACK message;
   In some embodiments the UE 120 shall always set the SCG state to deactivated when the condition(s) are fulfilled and the target configuration RRCReconfiguration** is applied;
   In some embodiments the UE 120 target configuration RRCReconfiguration** does not contain information about which SCG state to use;
Transmitting a response message, e.g., HANDOVER REQUEST ACKNOWLEDGE, to the source MN 111 that CHO with MR-DC has been configured;
Receiving a message from the UE 120, an RRCReconfigurationComplete containing a, to the T-SN, RRCReconfigurationComplete** indicating that the condition(s) in the UE 120 were fulfilled and that the UE 120 has applied the target configuration and CHO containing an MR-DC configuration;
Forwarding, to the T-SN 113, the RRCReconfigurationComplete** message;
Setting the SCG state of the UE 120 to deactivated;

Some embodiments comprise a method executed by the target candidate SN 113. This is related to and may be merged into the method performed by the third network node 113 described above. The method comprising:
Receiving a message from the target MN 112, the message requesting configuration of an SCG for a CHO with MR-DC configuration. The message containing the UE 120 current configuration, indicating that the UE 120 is configured with or is capable of deactivated SCG;
   The message being an S-NODE ADDITION REQUEST message;
   The current SCG configuration included in the target SN 113 configuration in CG-ConfigInfo;
   Information about the current SCG state for the UE 120 being included in the message.
Transmitting a message to the Master Node (MN), e.g., the MN 111, or MN 112, the message containing RRCReconfiguration** with the UE 120 target configuration;
   The message being an S-NODE ADDITION REQUEST ACK message;
   In some embodiments, the UE 120 shall always set the SCG state to deactivated when the condition(s) are fulfilled and the target configuration RRCReconfiguration** is applied;
   In some embodiments, the UE target configuration RRCReconfiguration** does not contain information about which SCG state to use;
Receiving, from the target MN 112, an RRCReconfigurationComplete** message indicating that the UE 120 has executed the conditional handover;
Setting the SCG state of the UE 120 to deactivated;

### The UE 120 Always Setting the SCG State of the SCG's Target Candidate to Activated

In a set of embodiments Some embodiments comprise a method executed by the UE 120 or e.g., the source MN 111. This is related to and may be merged into the method performed by the UE 120 or e.g., the source MN 111 described above. The method comprising:
Possibly having an MR-DC configuration and the SCG state possibly being set to activated or deactivated;
Receiving, from the network a CHO configuration containing an MR-DC configuration, which may correspond to an RRCReconfiguration message containing configuration of CHO with MR-DC in the target configuration, wherein the CHO configuration is to be applied when the condition(s) are fulfilled (wherein the SCG message to be applied may be denoted RRCReconfiguration**).
   In some embodiments the CHO configuration also comprises measurement configurations for the SCG, such as an SCG MeasConfig including the reporting configuration for configuring the event(s) for the execution condition(s) and/or the measurement object associated to the frequencies (e.g., SSB frequencies, SSB ARFCNs) of the target candidate PSCells, and the measurement identities to be referred in the CHO configuration for the target candidate(s).
Transmitting, to the network, an RRCReconfigurationComplete in response to that CHO with MR-DC was configured;
Receiving an indication (e.g., RRCReconfiguration message) from the network (e.g., from the network node operating as the MN or the network node operating as the SN) indicating an SCG state (mode of operation) and/or as change in the SCG state (mode of operation).
   For example, if the state was activated, this may be an indication to change it to deactivated or, if the state was deactivated, this may be an indication to change it to activated;
   While the UE 120 is configured with CHO with MR-DC and is monitoring the execution conditions for CHO with MR-DC the UE 120 may receive one or multiple indications for setting the SCG state.
   In some embodiments, the UE 120 receives the indication before it has been configured with CHO with MR-DC i.e. when the UE 120 is configured with CHO the UE 120 had already received the SCG state indication.
   In some embodiments, the UE 120 receives the indication after it has been configured with CHO with MR-DC.
   In some embodiments, the UE 120 receives the indication upon it has been configured with CHO with MR-DC i.e. in the same message the UE 120 is configured with CHO with MR-DC the UE 120 also receives the indication of the SCG state.
   This may be one or more indications for the SCG state of the current SCG, wherein the SCG state of the current SCG may be set to SCG deactivated or SCG activated; The current SCG is the SCG configured at the UE 120 at the moment the UE 120 receives the CHO with MR-DC configuration.
   The indication may be an indication in an MCG configuration, or an SCG configuration (e.g., generated by the network node operating as the SN).
Selecting a target candidate upon the fulfillment the execution condition, applying the target candidate configuration containing the selected target candidate MCG and SCG configuration; and
Setting the SCG state of the selected target candidate SCG to activated;
Upon applying the target candidate SCG configuration of the selected target candidate SCG (the target SCG may be the same as the source SCG), transmitting an RRCReconfigurationComplete to a first network node and performing further actions according to that determined SCG state of the selected target candidate SCG.
   In some embodiments, transmitting an RRC Reconfiguration Complete corresponds to transmitting an RRCReconfigurationComplete containing a RRCReconfigurationComplete** indicating that the condition(s) in the UE 120 were fulfilled and that the UE 120 has applied the target configuration, wherein the RRCReconfigurationComplete** is forwarded from the MN to the SN. The UE 120 is using the SCG state activated;
   In some embodiments, upon determining the state the UE 120 trigger a random access to the selected target SCG.

In one set of embodiments, some embodiments comprise a method executed by the source MN 111. This is related to and may be merged into the method performed by the first network node 11 described above. The method comprising:
Transmitting a message to the target candidate MN 112, the message requesting configuration of CHO with MR-DC configuration. The message containing the UE 120 current configuration, indicating that the UE 120 is configured with or is capable of deactivated SCG;
   In some embodiments the message being a HANDOVER REQUEST message;
   In some embodiments the current SCG configuration included in the SN configuration in HandoverPreparationInformation;
   In some embodiments the message includes the current SCG state of UE 120 e.g., activated SCG, deactivated SCG, which may be considered as part of the UE 120 configuration;
Receiving a message from the target candidate MN 112, the message containing the CHO with MR-DC configuration, comprising one or multiple target candidate MCG and SCG configuration(s) wherein each target candidate MCG and SCG configuration is to be applied by the UE 120 upon fulfillment of an execution condition that the UE 120 monitors upon reception of the CPC configuration, and wherein each target candidate SCG configuration is within an SCG RRC Reconfiguration message denoted RRCReconfiguration**;
   In some embodiments the message is a HANDOVER REQUEST ACKNOWLEDGE message;
   In some embodiments the UE 120 should always set the SCG state to activated when the condition(s) are fulfilled and the target configuration RRCReconfiguration** is applied
   In some embodiments the UE 120 target configuration RRCReconfiguration** does not contain information about which SCG state to use;
Transmitting, to the UE 120, an RRCReconfiguration message containing configuration of CHO with MR-DC;
Receiving, from the UE 120, an RRCReconfigurationComplete indicating that CHO with MR-DC was configured.

Some embodiments comprise a method executed by the target MN 112. This is related to and may be merged into the method performed by the second network node 112 described above. The method comprising:
Transmitting a message to the target candidate SN 113, the message requesting configuration of CHO with MR-DC configuration. The message containing the UE 120 current configuration, indicating that the UE 120 is configured with or is capable of deactivated SCG;
   In some embodiments the message being an S-NODE ADDITION REQUEST message;
   In some embodiments the current SCG configuration included in the target SN 113 configuration in CG-ConfigInfo;
   In some embodiments the message includes the current SCG state of UE 120 e.g., activated SCG, deactivated SCG, which may be considered as part of the UE 120 configuration;
   In some embodiments, the target MN 112 determines to configure the UE 120 with MR-DC in the CHO configuration.
Receiving a message from the target candidate SN 113, the message containing the SCG configuration, comprising one or multiple target candidate SCG configuration(s) wherein each target candidate SCG configuration is to be applied by the UE 120 upon fulfillment of an execution condition that the UE 120 monitors upon reception of the CHO configuration, and wherein each target candidate SCG configuration is within an SCG RRC Reconfiguration message denoted RRCReconfiguration**;
   In some embodiments the message is an S-NODE ADDITION REQUEST ACK message;
   In some embodiments the UE 120 shall always set the SCG state to activated when the condition(s) are fulfilled and the target configuration RRCReconfiguration** is applied;
   In some embodiments the UE 120 target configuration RRCReconfiguration** does not contain information about which SCG state to use;
Transmitting a response message, e.g., HANDOVER REQUEST ACKNOWLEDGE, to the source MN 111 that CHO with MR-DC has been configured;
Receiving a message from the UE 120, an RRCReconfigurationComplete containing a, to the T-SN, RRCReconfigurationComplete** indicating that the condition(s) in the UE 120 were fulfilled and that the UE 120 has applied the target configuration and CHO containing an MR-DC configuration;
Forwarding, to the Target (T)-SN 113, the RRCReconfigurationComplete** message, the message containing an indication of the current SCG state of the UE 120;

Some embodiments comprise a method executed by the target candidate SN 113. This is related to and may be merged into the method performed by the third network node 113 described above. The method comprising:
Receiving a message from the target MN 112, the message requesting configuration of an SCG for a CHO with MR-DC configuration. The message containing the UE 120 current configuration, indicating that the UE 120 is configured with or is capable of deactivated SCG;
   The message being an S-NODE ADDITION REQUEST message;
   The current SCG configuration included in the target SN 113 configuration in CG-ConfigInfo;
   Information about the current SCG state for the UE 120 being included in the message.
Transmitting a message to a MN such as e.g., the MN 112, or MN 111, the message containing RRCReconfiguration** with the UE 120 target configuration;
   The message being an S-NODE ADDITION REQUEST ACK message;
   In some embodiments, the UE 120 shall always set the SCG state to activated when the condition(s) are fulfilled and the target configuration RRCReconfiguration** is applied;
   In some embodiments, the UE 120 target configuration RRCReconfiguration** does not contain information about which SCG state to use;
Receiving, from the target MN 112, an RRCReconfigurationComplete** message indicating that the UE 120 has executed the conditional handover;
Setting the SCG state of the UE 120 to activated;

### UE 120 Setting the SCG State of the SCG's Target Candidate to a Pre-Configured Value

The method includes the UE 120 setting the SCG state of the SCG's target candidate to a value pre-configured by the MN such as e.g., the MN 111, e.g., activated or deactivated. The logic would be to let the target candidate MN 112 and/or the target candidate SN 113 to react and possibly deactivate the SCG after CHO execution depending on the traffic assessment after CHO execution. One benefit is that this works even if target candidates don't support deactivated SCG.

### The UE 120 Setting the SCG State of the SCG's Target Candidate to the Value Configured in the CHO+MR-DC Configuration

If the configuration for the target candidate includes an SCG configuration, consider the SCG state of the target candidate to be the state set in the SCG configuration, regardless of what the state of the current SCG is when the conditions are fulfilled and the handover is executed, and perform actions accordingly.

### The Source MN 111 Indicates Change of SCG State to the Candidate Target MN 112

In one set of embodiments Some embodiments comprise a method executed by the source MN 111. This is related to and may be merged into the method performed by the first network node 111 described above. The method comprising:
Transmitting a message to the target candidate MN 112, the message requesting configuration of CHO with MR-DC configuration. The message containing the UE 120 current configuration, indicating that the UE 120 is configured with or is capable of deactivated SCG;
   In some embodiments the message being a HANDOVER REQUEST message;
   In some embodiments the current SCG configuration included in the SN configuration in HandoverPreparationInformation;
   In some embodiments the message includes the current SCG state of UE 120 e.g., activated SCG, deactivated SCG, which may be considered as part of the UE 120 configuration;
Receiving a message from the target candidate MN 112, the message containing the CHO with MR-DC configuration, comprising one or multiple target candidate MCG and SCG configuration(s) wherein each target candidate MCG and SCG configuration is to be applied by the UE 120 upon fulfillment of an execution condition that the UE 120 monitors upon reception of the CPC configuration, and wherein each target candidate SCG configuration is within an SCG RRC Reconfiguration message denoted RRCReconfiguration**;
   In some embodiments the message is a HANDOVER REQUEST ACKNOWLEDGE message;
   In some embodiments the message contains an indication that the UE 120 is allowed to (and/or shall) continue using the same SCG state as it has when the condition(s) are fulfilled and the target configuration RRCReconfiguration** is applied; the indication may be the absence of a parameter whose its presence would have indicated an SCG deactivation; the indication may be the absence of a parameter whose its presence would have indicated an SCG deactivation and a second parameter indicating that the UE 120 may (and/or shall) continue using the current SCG state in the newly SCG being applied.
   In some embodiments the UE 120 target configuration RRCReconfiguration** does not contain information about which SCG state to use;
Transmitting, to the UE 120, an RRCReconfiguration message containing configuration of CHO with MR-DC;
Receiving, from the UE 120, an RRCReconfigurationComplete indicating that CHO with MR-DC was configured;
When there is a change of the SCG state of the UE 120 while it is configured with CHO with MR-DC (e.g., if the SCG state was activated and is changed to deactivated or if the SCG state was deactivated and is changed to activated), the source MN 111 transmits a UE 120-associated message, e.g., UE 120 CONFIGURATION UPDATE, to the target candidate MN 112 to inform about the change of current SCG state for the UE 120.
   In some embodiments the source Master Node (MN) 111 then receives a message from the target candidate Master Node (MN) 112 with an updated configuration for CHO with MR-DC, e.g., a configuration with an updated SCG configuration such as e.g., a different SCG state compared to the previous/current configuration, a configuration with a different SCG/PSCell/SN candidate, a CHO configuration without an MR-DC configuration or a change to that MR-DC (SCG) configuration has been added to a CHO configuration that previously did not include any MR-DC configuration. The change in configuration may then also include changes to the corresponding execution conditions. The source Master Node (MN) 111 then transmits an RRCReconfiguration message to the UE 120 to update the CHO configuration accordingly, e.g., by including the updated CHO with MR-DC (or just CHO) configuration to the UE 120.

Some embodiments comprise a method executed by the target MN 112. This is related to and may be merged into the method performed by the second network node 112 described above. The method comprising:
Transmitting a message to the target candidate SN 113, the message requesting configuration of CHO with MR-DC configuration. The message containing the UE 120 current configuration, indicating that the UE 120 is configured with or is capable of deactivated SCG;
   In some embodiments the message being an S-NODE ADDITION REQUEST message;
   In some embodiments the current SCG configuration included in the target SN 113 configuration in CG-ConfigInfo;
   In some embodiments the message includes the current SCG state of UE 120 e.g., activated SCG, deactivated SCG, which may be considered as part of the UE 120 configuration;
   In some embodiments, the target MN 112 determines to configure the UE 120 with MR-DC in the CHO configuration.
Receiving a message from the target candidate SN 113, the message containing the SCG configuration, comprising one or multiple target candidate SCG configuration(s) wherein each target candidate SCG configuration is to be applied by the UE 120 upon fulfillment of an execution condition that the UE 120 monitors upon reception of the CHO configuration, and wherein each target candidate SCG configuration is within an SCG RRC Reconfiguration message denoted RRCReconfiguration**;
   In some embodiments the message is an S-NODE ADDITION REQUEST ACK message;
   In some embodiments the message contains an indication that the UE 120 is allowed to (and/or shall) continue using the same SCG state as it has when the condition(s) are fulfilled and the target configuration RRCReconfiguration** is applied; the indication may be the absence of a parameter which presence would have indicated an SCG deactivation; the indication may be the absence of a parameter which presence would have indicated an SCG deactivation and a second parameter indicating that the UE 120 may (and/or shall) continue using the current SCG state in the newly SCG being applied.
   In some embodiments the UE 120 target configuration RRCReconfiguration** does not contain information about which SCG state to use;
Transmitting a response message, e.g., HANDOVER REQUEST ACK, to the source MN 111 that CHO with MR-DC has been configured;
Receiving a message from the source Master Node (MN) 111 informing that there is a change of the current SCG state of the UE 120 (e.g., that the SCG state for the UE 120 was activated and is changed to deactivated or that the SCG state for the UE 120 was deactivated and is changed to activated).
   In some embodiments, the target Master Node (MN) 112 transmits a message to the target candidate Secondary Node (SN) 113 to inform that the current SCG state for the UE 120 has changed (e.g., from deactivated to activated or from activated to deactivated)
   In some embodiments, the target Master Node (MN) 112 receives (in response to informing a target candidate Secondary Node (SN) 113 about the change of current SCG state for the UE 120) a message from the target candidate Secondary Node (SN) 113 with an updated SCG configuration for the CHO with MR-DC configuration.
   In some embodiments the target Master Node (MN) 112 determines, based on that it received information about the changed current state of the SCG and/or that it received an updated SCG configuration from the target candidate Secondary Node (SN) 113, that there should be a change of the MR-DC configuration as part of the CHO configuration. This may e.g., include a CHO configuration with an updated SCG configuration such as e.g., a different SCG state compared to the previous/current configuration, a CHO configuration with a different SCG/PSCell/SN candidate, a CHO configuration without an MR-DC configuration or a change to that MR-DC (SCG) configuration has been added to a CHO configuration that previously did not include any MR-DC configuration. The change in configuration may then also include changes to the corresponding execution conditions, e.g., for the SCG. The target Master Node (MN) 112 transmits a message to the source Master Node (MN) 111 to inform about the updated CHO configuration.
   In some embodiments, the target Master Node (MN) 112 stores the information about the current SCG state for the UE 120. When it then receives a message from the UE 120 (e.g., an RRCReconfigurationComplete containing a RRCReconfigurationComplete** to the T-SN 113) indicating that the condition(s) in the UE 120 were fulfilled and that the UE 120 has applied the target configuration and CHO containing an MR-DC configuration, it forwards the indication about the current SCG state to the target candidate Secondary Node (SN) 113.
Receiving a message from the UE 120, an RRCReconfigurationComplete containing a, to the T-SN, RRCReconfigurationComplete** indicating that the condition(s) in the UE 120 were fulfilled and that the UE 120 has applied the target configuration and CHO containing an MR-DC configuration;
Forwarding, to the T-SN 113, the RRCReconfigurationComplete** message, the message containing an indication of the current SCG state of the UE 120;

Some embodiments comprise a method executed by the target candidate SN 113. This is related to and may be merged into the method performed by the third network node 113 described above. The method comprising:
Receiving a message from the target Master Node (MN) 112, the message requesting configuration of an SCG for a CHO with MR-DC configuration. The message containing the UE 120 current configuration, indicating that the UE 120 is configured with or is capable of deactivated SCG;
   The message being an S-NODE ADDITION REQUEST message;
   The current SCG configuration included in the target SN 113 configuration in CG-ConfigInfo;
   Information about the current SCG state for the UE 120 being included in the message.
Transmitting a message to a Master Node (MN), the message containing RRCReconfiguration** with the UE 120 target configuration;
   The message being an S-NODE ADDITION REQUEST ACK message;
   In some embodiments, the message contains an indication that the UE 120 is allowed to continue using the same SCG state as it has when the condition(s) are fulfilled and the target configuration RRCReconfiguration** is applied;
   In some embodiments, the UE 120 target configuration RRCReconfiguration** does not contain information about which SCG state to use;
Receiving, from the target MN 112, a message that the current SCG state for the UE 120 has been changed (e.g., from deactivated to activated or from activated to deactivated).
In some embodiments, the target candidate Secondary Node (SN) 113 determines to update the SCG configuration for the UE 120's CHO configuration and transmits a message to the target MN 112 with the updated configuration. The change in SCG configuration may also include e.g., that one or more PSCell (SCG) configuration(s) are no longer part of the CHO configuration, e.g., so that the CHO configuration that previously included an SCG (MR-DC) configuration no longer includes any such configuration, or that a PSCell (SCG) configuration is added to the CHO configuration.
   The Source MN 111 Indicates Change of SCG State to the Candidate Target MN 112 after CHO Execution.

This is related to and may be merged into the method performed by the first network node 111 described above.

In an alternative solution, the source MN 111 indicates the SCG state to the target MN 112 after CHO execution. The target MN 112 informs the source MN 111 of the execution of the handover in a HANDOVER SUCCESS message. An indication of the SCG state may e.g., be included in a reply message to HANDOVER SUCCESS.

### Example Implementations

Example implementation of the above solution, highlighted by being underlined, indicating additions to 3GPP TS 38.331 v15.4.1, is shown below.

### RRCReconfiguration

The RRCReconfiguration message is the command to modify an RRC connection. It may convey information for measurement configuration, mobility control, radio resource configuration (including RBs, MAC main configuration and physical channel configuration) and AS security configuration.
Signalling radio bearer: SRB1 or SRB3
RLC-SAP: AM
Logical channel: DCCH
Direction: Network to UE 120

RRCReconfiguration message

```
-- ASN1START
-- TAG-RRCRECONFIGURATION-START
// other IEs from the message omitted for simplicity
RRCReconfiguration-v17xy-IEs ::= SEQUENCE {
    keepSCG-ActivationStateCHO-r16 BOOLEAN,
    nonCriticalExtension SEQUENCE { }
OPTIONAL
}|
-- TAG-RRCRECONFIGURATION-STOP
-- ASN1STOP
```

RRCReconfiguration-IEs field descriptions

keepSCG-ActivationStateCHO
Indicates whether the UE 120 shall keep the current SCG state
when a conditional reconfiguration is applied.

Example implementation of the above embodiments, highlighted by being underlined, indicating additions to 3GPP TS 38.423 v16.6.0, is provided below.

An example is shown of an S-NODE RECONFIGURATION COMPLETE containing information about the UE 120s current SCG status, forwarded to the T-SN e.g., T-SN 112 in the same message as the RRCReconfigurationComplete** message.

### 9.1.2.4 S-Node Reconfiguration Complete

This message is sent by the M-NG-RAN node, such as e.g., MN 112, to the S-NG-RAN node such as e.g., SN 113, to indicate whether the configuration requested by the S-NG-RAN node was applied by the UE 120, or to provide current SCG activation status of the UE 120.

Direction: M-NG-RAN node→S-NG-RAN node.

| | | | | | | |
|---|---|---|---|---|---|---|
| IE/Group Name | Presence | Range | IE type and reference | Semantics description | Criticality | Assigned Criticality |

| | | | | | |
|---|---|---|---|---|---|
| Message Type | M | 9.2.3.1 | | YES | reject |
| M-NG-RAN node | M | NG-RAN node UE | Allocated at the M-NG-RAN node | YES | reject |
| UE XnAP ID | | XnAP ID 9.2.3.16 | | | |
| S-NG-RAN node | M | NG-RAN node UE | Allocated at the S-NG-RAN node | YES | reject |
| UE XnAP ID | | XnAP ID 9.2.3.16 | | | |
| Response | M | | | YES | Ignore |
| Information | | | | | |
| >CHOICE | M | | | — | |
| Response Type | | | | | |
| >>Configuration | | | | — | |
| successfuly | | | | | |
| applied | | | | | |
| >>>M-NG-RAN | O | OCTET STRING | Includes the | — | |
| node to S-NG- | | | RRCReconfigurationComplete | | |
| RAN node | | | message as defined in subclause | | |
| Container | | | 6.2.2 of TS 38.331 [10] or the | | |
| | | | RRCConnectionReconfigurationComplete | | |
| | | | message as defined in | | |
| | | | subclause 6.2.2 of TS 36.331 [14]. | | |
| >>Configuration | | | | — | |
| rejected by the | | | | | |
| M-NG-RAN node | | | | | |
| >>>Cause | M | 9.2.3.2 | | — | |
| >>>M-NG-RAN | O | OCTET STRING | Includes the CG-ConfigInfo | — | |
| node to S-NG- | | | message as defined in as defined in | | |
| RAN node | | | subclause 11.2.2 of TS 38.331 [10]. | | |
| Container | | | | | |
| >>SCG | | | | — | |
| Activation Status | | | | | |
| >>>SCG | O | ENUMERATED | | — | |
| Activation Status | | (SCG activated, | | | |
| | | SCG deactivated, . . . ) | | | |

An example is shown of a new message named UE 120 CONFIGURATION UPDATE containing information about the UE 120's current SCG status.

### 9.1.2.xxx UE Configuration Update

This message is sent by the source NG-RAN node such as e.g., source network node 111 to the target NG-RAN node, such as e.g., target network node 112 or 113, to provide the updated configuration of the UE such as e.g., the UE 120.

Direction: source NG-RAN node→target NG-RAN node.

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | 9.2.3.1 | | YES | reject |
| Source NG-RAN node UE | M | NG-RAN node | Allocated at | YES | ignore |
| XnAP ID | | UE XnAP ID | the source | | |
| | | 9.2.3.16 | NG-RAN node. | | |
| Target NG-RAN node UE | M | NG-RAN node | Allocated at | YES | ignore |
| XnAP ID | | UE XnAP ID | the target | | |
| | | 9.2.3.16 | NG-RAN node. | | |
| SCG Activation Status | M | ENUMERATED | | YES | ignore |
| | | (SCG activated, | | | |
| | | SCG | | | |
| | | deactivated, . . . ) | | | |

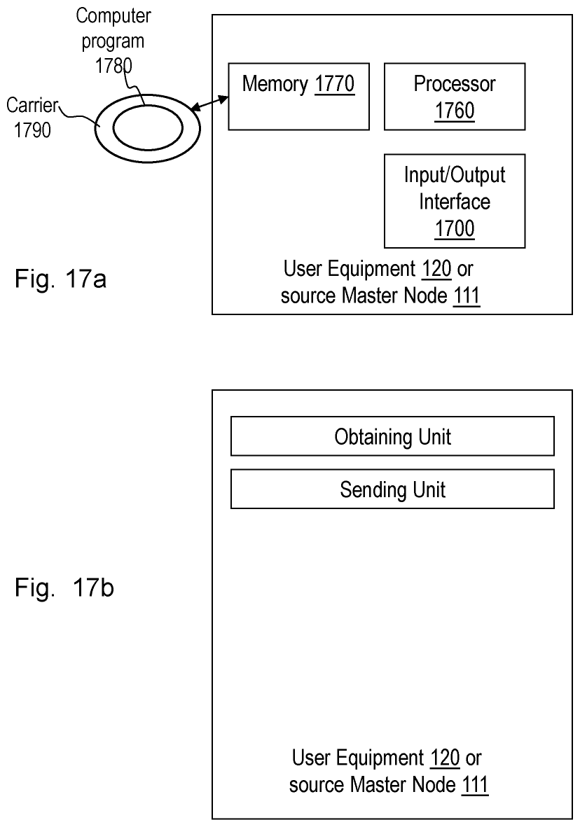

FIGS. 17a and 17b shows an example of an arrangement in the UE 120 or source MN 111.

The UE 120 or source MN 111 may comprise an input and output interface 1700 configured to communicate e.g., with any of the networking entities operating in the wireless communications network 100 of embodiments herein. The input and output interface 1700 may comprise a receiver, e.g., wired and/or wireless, (not shown) and a transmitter, e.g., wired and/or wireless, (not shown).

The UE 120 or source MN 111 may comprise any one or more out of: an obtaining unit and a sending unit to perform the method actions as described herein, e.g., actions 1201-1204 above. These units are further described under example embodiments below.

The embodiments herein may be implemented through a respective processor or one or more processors, such as at least one processor 1760 of a processing circuitry in the UE 120 or source MN 111 depicted in FIG. 17a, together with computer program code for performing the functions and actions of the embodiments herein. The program code mentioned above may also be provided as a computer program product, for instance in the form of a data carrier carrying computer program code for performing the embodiments herein when being loaded into the UE 120 or source MN 111. One such carrier may be in the form of a CD ROM disc. It is however feasible with other data carriers such as a memory stick. The computer program code may furthermore be provided as pure program code on a server and downloaded to the UE 120 or source MN 111.

The UE 120 or source MN 111 may further comprise a memory 1770 comprising one or more memory units. The memory 1770 comprises instructions executable by the processor in the UE 120 or source MN 111. The memory 1770 is arranged to be used to store instructions, data, configurations, and applications to perform the methods herein when being executed in the UE 120 or source MN 111.

In some embodiments, a computer program 1780 comprises instructions, which when executed by the at least one processor 1760, cause the at least one processor 1760 of the UE 120 or source MN 111 to perform the actions above.

In some embodiments, a respective carrier 1790 comprises the respective computer program 1780, wherein the carrier 1790 is one of an electronic signal, an optical signal, an electromagnetic signal, a magnetic signal, an electric signal, a radio signal, a microwave signal, or a computer-readable storage medium.

Those skilled in the art will also appreciate that the functional modules in the UE 120 or source MN 111, described below may refer to a combination of analog and digital circuits, and/or one or more processors configured with software and/or firmware, e.g., stored in the UE 120 or source MN 111, that when executed by the respective one or more processors such as the at least one processor 1760 described above cause the respective at least one processor 1760 to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

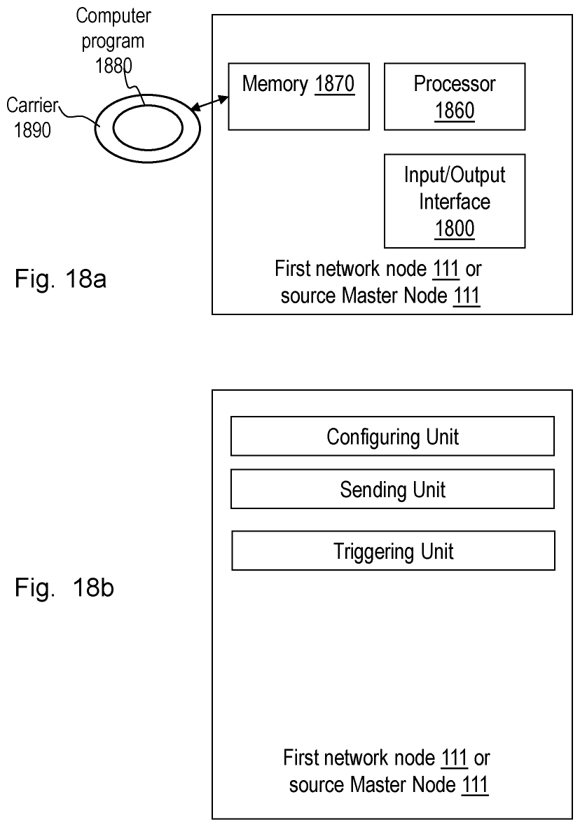

FIGS. 18a and 18b shows an example of an arrangement in the first network node 111 or source MN 111.

The first network node 111 or source MN 111 may comprise an input and output interface 1800 configured to communicate e.g., with any of the networking entities operating in the wireless communications network 100 of embodiments herein. The input and output interface 1800 may comprise a receiver, e.g., wired and/or wireless, (not shown) and a transmitter, e.g., wired and/or wireless, (not shown).

The first network node 111 or source MN 111 may comprise any one or more out of: A configuring unit, a sending unit, and a triggering unit to perform the method actions as described herein e.g., actions 1301-1303 above. These units are further described under example embodiments below.

The embodiments herein may be implemented through a respective processor or one or more processors, such as at least one processor 1860 of a processing circuitry in the first network node 111 or source MN 111 depicted in FIG. 18a, together with computer program code for performing the functions and actions of the embodiments herein. The program code mentioned above may also be provided as a computer program product, for instance in the form of a data carrier carrying computer program code for performing the embodiments herein when being loaded into the first network node 111 or source MN 111. One such carrier may be in the form of a CD ROM disc. It is however feasible with other data carriers such as a memory stick. The computer program code may furthermore be provided as pure program code on a server and downloaded to the first network node 111 or source MN 111.

The first network node 111 or source MN 111 may further comprise a memory 1870 comprising one or more memory units. The memory 1870 comprises instructions executable by the processor in the first network node 111 or source MN 111. The memory 1870 is arranged to be used to store instructions, data, configurations, and applications to perform the methods herein when being executed in the first network node 111 or source MN 111.

In some embodiments, a computer program 1880 comprises instructions, which when executed by the at least one processor 1860, cause the at least one processor 1860 of the first network node 111 or source MN 111 to perform the actions above.

In some embodiments, a respective carrier 1890 comprises the respective computer program 1880, wherein the carrier 1890 is one of an electronic signal, an optical signal, an electromagnetic signal, a magnetic signal, an electric signal, a radio signal, a microwave signal, or a computer-readable storage medium.

Those skilled in the art will also appreciate that the functional modules in the first network node 111 or source MN 111, described below may refer to a combination of analog and digital circuits, and/or one or more processors configured with software and/or firmware, e.g., stored in the first network node 111 or source MN 111, that when executed by the respective one or more processors such as the at least one processor 1860 described above cause the respective at least one processor 1860 to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

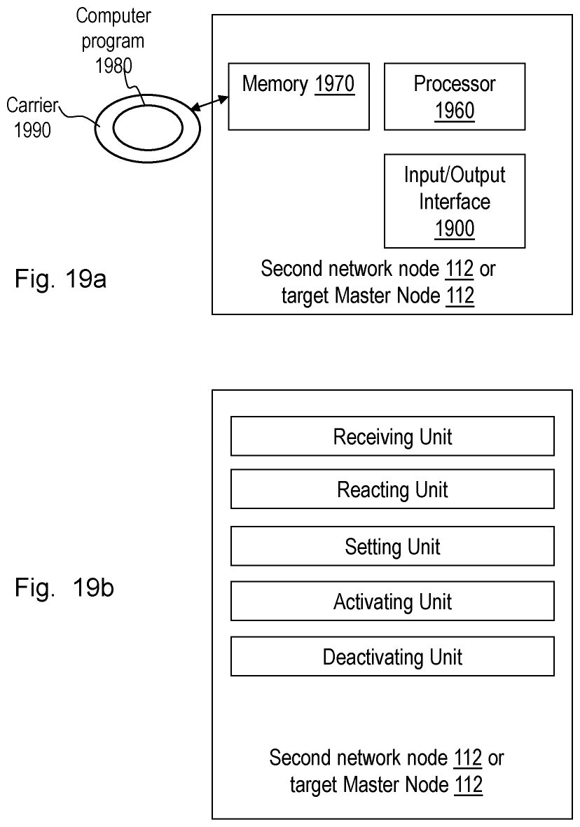

FIGS. 19a and 19b shows an example of an arrangement in the second network node 112 or target MN 112.

The second network node 112 or target MN 112 may comprise an input and output interface 1900 configured to communicate with e.g., with any of the networking entities operating in the wireless communications network 100 of embodiments herein. The input and output interface 1900 may comprise a receiver, e.g., wired and/or wireless, (not shown) and a transmitter, e.g., wired and/or wireless, (not shown).

The second network node 112 or target MN 112 may comprise any one or more out of: A receiving unit, a reacting unit, a setting unit, an activating unit, and a deactivating unit to perform the method actions as described herein, e.g., action 1401 above. These units are further described under example embodiments below.

The embodiments herein may be implemented through a respective processor or one or more processors, such as at least one processor 1960 of a processing circuitry in the second network node 112 or target MN 112 depicted in FIG. 19a, together with computer program code for performing the functions and actions of the embodiments herein. The program code mentioned above may also be provided as a computer program product, for instance in the form of a data carrier carrying computer program code for performing the embodiments herein when being loaded into the second network node 112 or target MN 112. One such carrier may be in the form of a CD ROM disc. It is however feasible with other data carriers such as a memory stick. The computer program code may furthermore be provided as pure program code on a server and downloaded to the second network node 112 or target MN 112.

The second network node 112 or target MN 112 may further comprise a memory 1970 comprising one or more memory units. The memory 1970 comprises instructions executable by the processor in the second network node 112 or target MN 112. The memory 1970 is arranged to be used to store instructions, data, configurations, and applications to perform the methods herein when being executed in the second network node 112 or target MN 112.

In some embodiments, a computer program 1980 comprises instructions, which when executed by the at least one processor 1960, cause the at least one processor 1960 of the second network node 112 or target MN 112 to perform the actions above.

In some embodiments, a respective carrier 1990 comprises the respective computer program 1980, wherein the carrier 1990 is one of an electronic signal, an optical signal, an electromagnetic signal, a magnetic signal, an electric signal, a radio signal, a microwave signal, or a computer-readable storage medium.

Those skilled in the art will also appreciate that the functional modules in the second network node 112 or target MN 112, described below may refer to a combination of analog and digital circuits, and/or one or more processors configured with software and/or firmware, e.g., stored in the second network node 112 or target MN 112, that when executed by the respective one or more processors such as the at least one processor 1960 described above cause the respective at least one processor 1960 to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

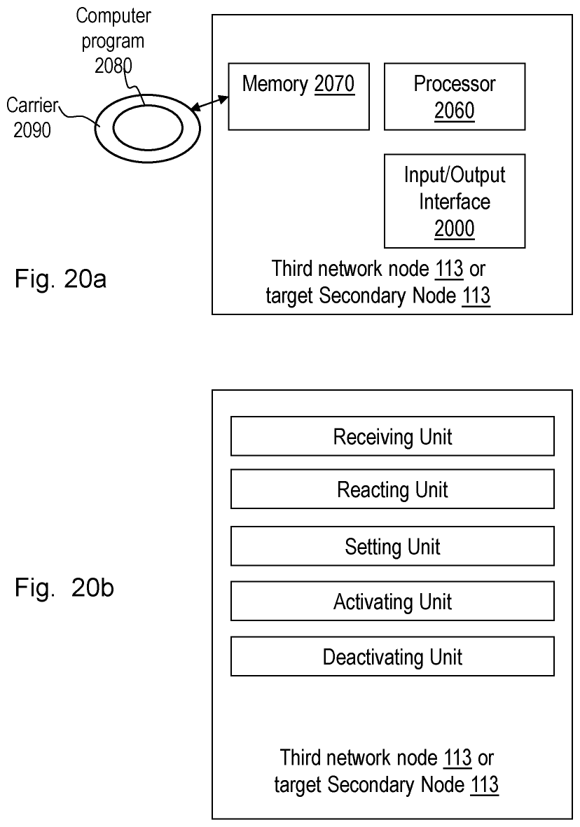

FIGS. 20a and 20b shows an example of an arrangement in the third network node 113 or target SN 113.

The third network node 113 or target SN 113 may comprise an input and output interface 2000 configured to communicate with e.g., with any of the networking entities operating in the wireless communications network 100 of embodiments herein. The input and output interface 2000 may comprise a receiver, e.g., wired and/or wireless, (not shown) and a transmitter, e.g., wired and/or wireless, (not shown).

The third network node 113 or target SN 113 may comprise any one or more out of: A receiving unit, a reacting unit, a setting unit, an activating unit, and a deactivating unit to perform the method actions as described herein, e.g., action 1504 above. These units are further described under example embodiments below.

The embodiments herein may be implemented through a respective processor or one or more processors, such as at least one processor 2060 of a processing circuitry in the third network node 113 or target SN 113 depicted in FIG. 20a, together with computer program code for performing the functions and actions of the embodiments herein. The program code mentioned above may also be provided as a computer program product, for instance in the form of a data carrier carrying computer program code for performing the embodiments herein when being loaded into the third network node 113 or target SN 113. One such carrier may be in the form of a CD ROM disc. It is however feasible with other data carriers such as a memory stick. The computer program code may furthermore be provided as pure program code on a server and downloaded to the third network node 113 or target SN 113.

The third network node 113 or target SN 113 may further comprise a memory 2070 comprising one or more memory units. The memory 2070 comprises instructions executable by the processor in the third network node 113 or target SN 113. The memory 2070 is arranged to be used to store instructions, data, configurations, and applications to perform the methods herein when being executed in the third network node 113 or target SN 113.

In some embodiments, a computer program 2080 comprises instructions, which when executed by the at least one processor 2060, cause the at least one processor 2060 of the third network node 113 or target SN 113 to perform the actions above.

In some embodiments, a respective carrier 2090 comprises the respective computer program 2080, wherein the carrier 2090 is one of an electronic signal, an optical signal, an electromagnetic signal, a magnetic signal, an electric signal, a radio signal, a microwave signal, or a computer-readable storage medium.

Those skilled in the art will also appreciate that the functional modules in the third network node 113 or target SN 113, described below may refer to a combination of analog and digital circuits, and/or one or more processors configured with software and/or firmware, e.g., stored in the third network node 113 or target SN 113, that when executed by the respective one or more processors such as the at least one processor 2060 described above cause the respective at least one processor 2060 to perform actions according to any of the actions above. One or more of these processors, as well as the other digital hardware, may be included in a single Application-Specific Integrated Circuitry (ASIC), or several processors and various digital hardware may be distributed among several separate components, whether individually packaged or assembled into a system-on-a-chip (SoC).

The embodiments herein are not limited to the above described preferred embodiments. Various alternatives, modifications and equivalents may be used.

Below, some example embodiments 1-22 are shortly described. See e.g., FIGS. 12, 13, 14, 15, 17a, 17b, 18a, 18b, 19a, 19b, 20a, and 20b.

Embodiment 1. A method performed by a User Equipment, UE, 120 also referred to as a wireless device or a wireless terminal, or e.g., performed by a source MN 111, for indicating a Secondary Cell Group, SCG, state during a Conditional Handover, CHO, in a wireless communications network 100, which UE 120 e.g., is configured with a current SCG, the method e.g., comprising:
obtaining from a source MN 111, a Conditional Handover, CHO, configuration for the UE 120, which CHO configuration comprises a configuration for a target candidate node 112, 113, which target candidate node 112, 113 comprises any one or more out of: a target candidate Master Node, MN, 112 and a target candidate Secondary Node, SN, 113,
e.g., when CHO execution conditions related to the CHO configuration are fulfilled, sending an indication to the target candidate node 112, 113, which indication indicates an SCG state being set to any one out of: SCG activated or SCG deactivated.

Embodiment 2. The method according to embodiment 1, wherein the SCG state is set according to any one out of the current SCG state, and/or a target SCG state.

Embodiment 3. The method according to any of the embodiments 1-2, further comprising:
obtaining, such as e.g., receiving, a current SCG state, e.g., meaning that it is the SCG state that the UE 120 has when the CHO execution is started, E.g., towards the source SN, which btw may be the same node as the target SN, e.g., since the same PSCell/SCG is kept at the HO, which current SCG state is set to any one out of: SCG activated or SCG deactivated,
and wherein the indication to the target candidate node 112, 113 indicates the current SCG state, which indication will set a target SCG state to SCG activation or SCG deactivation, initiated by the selected target candidate node 112, 113, e.g., comprising any one or more out of: the target candidate MN 112 and/or the target candidate SN 113.

This may e.g., mean to set the SCG state towards the target SN, as part of applying the CHO configuration with SCG and that the UE 120 and the target network nodes 112, 113 then act accordingly.

Embodiment 4. The method according to any of the embodiments 1-2, wherein:
obtaining, e.g., by setting, a target SCG state to any one out of:
   always deactivated,
   always activated,
   a value pre-configured, e.g., by the source MN 111, as activated or deactivated,
   a the latest SCG state the UE 120 has when CHO is executed, e.g., the current SCG state, and
wherein the indication to the target candidate node 112, 113 indicates the target SCG state.

Embodiment 5. A computer program comprising instructions, which when executed by a processor, causes the processor to perform actions according to any of the embodiments 1-4.

Embodiment 6. A carrier comprising the computer program of embodiment 5, wherein the carrier is one of an electronic signal, an optical signal, an electromagnetic signal, a magnetic signal, an electric signal, a radio signal, a microwave signal, or a computer-readable storage medium.

Embodiment 7. A method performed by a first network node 111 acting as a source Master Node, MN, 111, for handling a Secondary Cell Group, SCG, state during a Conditional Handover, CHO, for a User Equipment, UE, 120 in a wireless communications network 100, which UE 120 e.g., is configured with a current SCG, the method e.g., comprising:
sending to the UE 120, a Conditional Handover, CHO, configuration for the UE 120, which CHO configuration comprises a configuration for a target candidate node 112, 113, which target candidate node 112, 113 comprises any one or more out of: a target candidate Master Node, MN, 112 and a target candidate Secondary Node, SN, 113,
which CHO, configuration triggers the UE 120 to e.g., when CHO execution conditions relating to the CHO configuration are fulfilled, send an indication to the target candidate node 112, 113, which indication indicates an SCG state being set to any one out of: SCG activated or SCG deactivated.

Embodiment 8. The method according to embodiment 7, wherein SCG state comprises any one out of the current SCG state, and/or a target SCG state.

Embodiment 9. The method according to any of the embodiments 7-8, further comprising:
sending to the UE 120, a current SCG state, which current SCG state is set to any one out of: SCG activated or SCG deactivated,
and wherein the indication to the target candidate node 112, 113 indicates the current SCG state, which indication will set a target SCG state to SCG activation or SCG deactivation, initiated by the selected target candidate node 112, 113 e.g., comprising any one or more out of: the target candidate MN 112 and/or the target candidate SN 113.

Embodiment 10. The method according to embodiment 7-8, wherein:
configuring the UE 120 with a target SCG state set to any one out of:
   always deactivated,
   always activated,
   a value pre-configured as activated or deactivated,
   a latest SCG state the UE 120 has when CHO is executed, and
and wherein the indication indicates the target SCG state.

Embodiment 11. A computer program comprising instructions, which when executed by a processor, causes the processor to perform actions according to any of the embodiments 7-10.

Embodiment 12. A carrier comprising the computer program of embodiment 11, wherein the carrier is one of an electronic signal, an optical signal, an electromagnetic signal, a magnetic signal, an electric signal, a radio signal, a microwave signal, or a computer-readable storage medium.

Embodiment 13. A method performed by a second network node 112 acting as a target Master Node, MN, 112 for handling a Secondary Cell Group, SCG, state during a Conditional Handover, CHO, for a User Equipment, UE, 120 in a wireless communications network 100, which UE 120 e.g., is configured with a current SCG, the method e.g., comprising:
e.g., when CHO execution conditions relating to a CHO configuration are fulfilled, receiving an indication from the UE 120, which indication indicates an SCG state being set to any one out of: SCG activated or SCG deactivated.

Embodiment 14. The method according to embodiment 13, wherein SCG state comprises any one out of the current SCG state, and/or a target SCG state.

Embodiment 15. The method according to any of the embodiments 13-14, further comprising:
when the indication indicates a current SCG state, setting a target SCG state to SCG activation or SCG deactivation, based on the indication.

Embodiment 16. The method according to any of the embodiments 13-14, comprising any one out of:
when the indication indicates a target SCG state comprises deactivated, reacting and activating the SCG after CHO execution depending on the traffic assessment after CHO execution,
when the indication indicates a target SCG state comprises activated, reacting and possibly deactivating the SCG after CHO execution depending on the traffic assessment after CHO execution,
when the indication indicates a target SCG state comprises a pre-configured, value as activated or deactivated, reacting and possibly deactivating the SCG after CHO execution depending on the traffic assessment after CHO execution.

Embodiment 17. A computer program comprising instructions, which when executed by a processor, causes the processor to perform actions according to any of the embodiments 13-16.

Embodiment 18. A carrier comprising the computer program of embodiment 17, wherein the carrier is one of an electronic signal, an optical signal, an electromagnetic signal, a magnetic signal, an electric signal, a radio signal, a microwave signal, or a computer-readable storage medium.

Embodiment 19. A method performed by a third network node 113 acting as a target Secondary Node, SN, 113 for handling a Secondary Cell Group, SCG, state during a Conditional Handover, CHO, for a User Equipment, UE, 120 in a wireless communications network 100, which UE 120 e.g., is configured with a current SCG, the method e.g., comprising:
e.g., when CHO execution conditions relating to a CHO configuration are fulfilled, receiving an indication from the UE 120, which indication indicates an SCG state being set to any one out of: SCG activated or SCG deactivated.

Embodiment 20. The method according to embodiment 19, wherein SCG state comprises any one out of the current SCG state, and/or a target SCG state.

Embodiment 21. The method according to any of the embodiments 19-20, further comprising:

when the indication indicates a current SCG state, setting a target SCG state to SCG activation or SCG deactivation, based on the indication.

Embodiment 22. The method according to any of the embodiments 19-20, comprising any one out of:
when the indication indicates a target SCG state comprises deactivated, reacting and activating the SCG after CHO execution depending on the traffic assessment after CHO execution,
when the indication indicates a target SCG state comprises activated, reacting and possibly deactivating the SCG after CHO execution depending on the traffic assessment after CHO execution,
when the indication indicates a target SCG state comprises a pre-configured, value as activated or deactivated, reacting and possibly deactivating the SCG after CHO execution depending on the traffic assessment after CHO execution.

Embodiment 23. A computer program comprising instructions, which when executed by a processor, causes the processor to perform actions according to any of the embodiments 19-22.

Embodiment 24. A carrier comprising the computer program of embodiment 23, wherein the carrier is one of an electronic signal, an optical signal, an electromagnetic signal, a magnetic signal, an electric signal, a radio signal, a microwave signal, or a computer-readable storage medium.

Embodiment 25. A User Equipment, UE, 120 also referred to as a wireless device or a wireless terminal, or e.g., a source MN 111, configured to indicate a Secondary Cell Group, SCG, state during a Conditional Handover, CHO, in a wireless communications network 100, which UE 120 or source MN 111 e.g., is configured with a current SCG, the UE 120 or source MN 111 is e.g., further configured to:
obtain, e.g., by means of an obtaining unit in the UE 120 or the source MN 111, from a source MN 111, a Conditional Handover, CHO, configuration for the UE 120, which CHO configuration is adapted to comprise a configuration for a target candidate node 112, 113, which target candidate node 112, 113 is arranged to comprise any one or more out of: a target candidate Master Node, MN, 112 and a target candidate Secondary Node, SN, 113,
e.g., when CHO execution conditions related to the CHO configuration are adapted to be fulfilled, send, e.g., by means of a sending unit in the UE 120 or the source MN 111, an indication to the target candidate node 112, 113, which indication is adapted to indicate an SCG state being set to any one out of: SCG activated or SCG deactivated.

Embodiment 26. The UE 120 or the source MN 111, according to embodiment 26, wherein the SCG state is adapted to be set according to any one out of the current SCG state, and/or a target SCG state.

Embodiment 27. The UE 120 or the source MN 111 according to any of the embodiments 25-26, e.g., further configured to:
obtain, e.g., by means of the obtaining unit in the UE 120 or the source MN 111, such as e.g., receive, a current SCG state, which current SCG state is adapted to be set to any one out of: SCG activated or SCG deactivated,
and wherein the indication to the target candidate node 112, 113 is adapted to indicate the current SCG state, which indication will set a target SCG state to SCG activation or SCG deactivation, initiated by the selected target candidate node 112, 113, e.g., comprising any one or more out of: the target candidate MN 112 and/or the target candidate SN 113.

Embodiment 28. The UE 120 or the source MN 111 according to any of the embodiments 25-27, e.g., further configured to:
obtain, e.g., by means of the obtaining unit in the UE 120 or the source MN 111, e.g., by setting, a target SCG state adapted to be any one out of:
   always deactivated,
   always activated,
   a value pre-configured, e.g., by the source MN 111, as activated or deactivated,
   a the latest SCG state the UE 120 has when CHO is executed, e.g., the current SCG state, and
wherein the indication to the target candidate node 112, 113 is adapted to indicate the target SCG state.

Embodiment 29. A first network node 111 acting as a source Master Node, MN, 111, configured to handle a Secondary Cell Group, SCG, state during a Conditional Handover, CHO, for a User Equipment, UE, 120 in a wireless communications network 100, which UE 120 e.g., is arranged to be configured with a current SCG, the first network node 111 is e.g., further configured to:
send, e.g., by means of a sending unit in the first network node 111, to the UE 120, a Conditional Handover, CHO, configuration for the UE 120, which CHO configuration is adapted to comprise a configuration for a target candidate node 112, 113, which target candidate node 112, 113 is arranged to comprise any one or more out of: a target candidate Master Node, MN, 112 and a target candidate Secondary Node, SN, 113,
which CHO configuration is adapted to trigger, e.g., by means of a triggering unit in the first network node 111, the UE 120 to e.g., when CHO execution conditions relating to the CHO configuration are adapted to be fulfilled, send, e.g., by means of the sending unit in the first network node 111, an indication to the target candidate node 112, 113, which indication is adapted to indicate an SCG state being set to any one out of: SCG activated or SCG deactivated.

Embodiment 30. The first network node 111 according to embodiment 29, wherein the SCG state is adapted to comprise any one out of the current SCG state, and/or a target SCG state.

Embodiment 31. The first network node 111 according to any of the embodiments 29-30, further configured to:
send, e.g., by means of the sending unit in the first network node 111, to the UE 120, a current SCG state, which current SCG state is adapted to be set to any one out of: SCG activated or SCG deactivated,
and wherein the indication to the target candidate node 112, 113 is adapted to indicate the current SCG state, which indication will set a target SCG state to SCG activation or SCG deactivation, initiated by the selected target candidate node 112, 113 e.g., comprising any one or more out of: the target candidate MN 112 and/or the target candidate SN 113.

Embodiment 32. The first network node 111 according to embodiment 29-31, further configured to:
configure, e.g., by means of a configuring unit in the first network node 111, the UE 120 with a target SCG state set adapted to be any one out of:
   always deactivated,
   always activated,
   a value pre-configured as activated or deactivated,
   a latest SCG state the UE 120 has when CHO is executed, and
and wherein the indication indicate the target SCG state,

Embodiment 33. A second network node 112 acting as a target Master Node, MN, 112 configured to handle a Secondary Cell Group, SCG, state during a Conditional Handover, CHO, for a User Equipment, UE, 120 in a wireless communications network 100, which UE 120 e.g., is adapted to be configured with a current SCG, the second network node 112 e.g., is further configured to:
e.g., when CHO execution conditions relating to a CHO configuration are adapted to be fulfilled, receive, e.g., by means of a receiving unit in the second network node 112, an indication from the UE 120, which indication is adapted to indicate an SCG state being set to any one out of: SCG activated or SCG deactivated.

Embodiment 34. The second network node 112 according to embodiment 33, wherein the SCG state is adapted to comprise any one out of the current SCG state, and/or a target SCG state.

Embodiment 35. The second network node 112 according to any of the embodiments 33-34, further configured to:
when the indication is adapted to indicate a current SCG state, set, e.g., by means of a setting unit in the second network node 112, a target SCG state to SCG activation or SCG deactivation, based on the indication.

Embodiment 36. The second network node 112 according to any of the embodiments 33-35, further configured to any one out of:
when the indication is adapted to indicate a target SCG state comprising deactivated, react, e.g., by means of a reacting unit in the second network node 112, and activate, e.g., by means of an activating unit in the second network node 112, the SCG after CHO execution depending on the traffic assessment after CHO execution,
when the indication is adapted to indicate a target SCG state comprising, activated, react, e.g., by means of the reacting unit in the second network node 112, and possibly deactivate, e.g., by means of a deactivating unit in the second network node 112, the SCG after CHO execution depending on the traffic assessment after CHO execution,
when the indication is adapted to indicate a target SCG state comprising a pre-configured, value as activated or deactivated, react, e.g., by means of the reacting unit in the second network node 112, and possibly deactivate, e.g., by means of the deactivating unit in the second network node 112, the SCG after CHO execution depending on the traffic assessment after CHO execution.

Embodiment 37. A third network node 113 acting as a target Secondary Node, SN, 113 configured to handle a Secondary Cell Group, SCG, state during a Conditional Handover, CHO, for a User Equipment, UE, 120 in a wireless communications network 100, which UE 120 e.g., is adapted to be configured with a current SCG, the third network node 113 e.g., is further configured to:
e.g., when CHO execution conditions relating to a CHO configuration are adapted to be fulfilled, receive, e.g., by means of a receiving unit in the third network node 113, an indication from the UE 120, which indication is adapted to indicate an SCG state being set to any one out of: SCG activated or SCG deactivated.

Embodiment 38. The third network node 113 according to embodiment 37, wherein the SCG state is adapted to comprise any one out of the current SCG state, and/or a target SCG state.

Embodiment 39. The third network node 113 according to any of the embodiments 37-38, further configured to:
when the indication is adapted to indicate a current SCG state, set, e.g., by means of a setting unit in the third network node 113, a target SCG state to SCG activation or SCG deactivation, based on the indication.

Embodiment 40. The third network node 113 according to any of the embodiments 37-39, further configured to any one out of:
when the indication is adapted to indicate a target SCG state comprising deactivated, react, e.g., by means of a reacting unit in the third network node 113, and activate, e.g., by means of an activating unit in the third network node 113, the SCG after CHO execution depending on the traffic assessment after CHO execution,
when the indication is adapted to indicate a target SCG state comprising activated, react, e.g., by means of the reacting unit in the third network node 113, and possibly deactivate, e.g., by means of a deactivating unit in the third network node 113, the SCG after CHO execution depending on the traffic assessment after CHO execution,
when the indication is adapted to indicate a target SCG state comprising a pre-configured, value as activated or deactivated, react, e.g., by means of the reacting unit in the third network node 113, and possibly deactivate, e.g., by means of the deactivating unit in the third network node 113, the SCG after CHO execution depending on the traffic assessment after CHO execution.

| Abbreviation | Explanation |
|---|---|
| 5GC or 5GCN | 5G core network |
| ACK | Acknowledgement |
| AGC | Automatic Gain Control |
| AMF | Access and Mobility management Function |
| AP | Application Protocol |
| BSR | Buffer Status Report |
| BWP | Bandwidth Part |
| C-RNTI | Cell Radio Network Temporary Identifier |
| CA | Carrier Aggregation |
| CE | Control Element |
| CHO | Conditional Handover |
| CN | Core Network |
| CPA | Conditional PSCell Addition |
| CPC | Conditional PSCell Change |
| CP | Control Plane |
| CQI | Channel Quality Indicator |
| C-RNTI | Cell Radio Network Temporary Identifier |
| CSI | Channel State Information |
| DC | Dual Connectivity |
| DCI | Downlink Control Information |
| DL | Downlink |
| DRB | Data Radio Bearer |
| eNB | (EUTRAN) base station |
| E-RAB | EUTRAN Radio Access Bearer |
| E-UTRA | Evolved Universal Terrestrial Radio Access |
| E-UTRAN | Evolved Universal Terrestrial Radio Access Network |
| FDD | Frequency Division Duplex |
| gNB | NR base station |
| GTP-U | GPRS Tunneling Protocol - User Plane |
| IE | Information Element |
| IP | Internet Protocol |
| LTE | Long Term Evolution |
| MCG | Master Cell Group |
| MAC | Medium Access Control |
| MAC CE | MAC Control Element |
| MeNB | Master eNB |
| MgNB | Master gNB |
| MN | Master Node |
| MR-DC | Multi-Radio Dual Connectivity |
| NACK | Negative Acknowledgement |
| NAS | Non Access Stratum |
| NG-RAN | Next Generation Radio Access Network |
| Ng-eNB | Next Generation Evolved Node B |
| NR | New Radio |
| PDCP | Packet Data Convergence Protocol |
| PCell | Primary Cell |
| PCI | Physical Cell Identity |
| PDCCH | Physical Downlink Control Channel |
| PHR | Power headroom report |
| PSCell | Primary Secondary Cell (in LTE) or Primary |
| | SCG Cell (in NR) |
| PUCCH | Physical Uplink Control Channel |
| PUSCH | Phyical Uplink Shared Channel |
| RACH | Random Access Channel |
| RAT | Radio Access Technology |
| RB | Radio Bearer |
| RLC | Radio Link Control |
| RLF | Radio Link Failure |
| RRC | Radio Resource Control |
| SCell | Secondary Cell |
| SCG | Secondary Cell Group |
| SCTP | Stream Control Transmission Protocol |
| SeNB | Secondary eNB |
| SgNB | Secondary gNB |
| SINR | Signal to Interference plus Noise Ratio |
| SN | Secondary Node |
| SR | Scheduling Request |
| SRB | Signaling Radio Bearer |
| S-SN | Source Secondary Node |
| SUL | Supplementary uplink |
| SpCell | Special Cell, the primary cell of a master or |
| | secondary cell group |
| TAT | Time Alignment Timer |
| TDD | Time Division Duplex |
| TEID | Tunnel Endpoint IDentifier |
| TNL | Transport Network Layer |
| T-SN | Target Secondary Node |

### Further Extensions and Variations

With reference to FIG. 21, in accordance with an embodiment, a communication system includes a telecommunication network 3210 such as the wireless communication network 100, e.g., an IoT network, or a WLAN, such as a 3GPP-type cellular network, which comprises an access network 3211, such as a radio access network, and a core network 3214. The access network 3211 comprises a plurality of base stations 3212a, 3212b, 3212c, such as the first, second, or third network nodes 111, 112, 113, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first UE e.g., the UE 120, such as a Non-AP STA 3291 located in coverage area 3213c is configured to wirelessly connect to, or be paged by, the corresponding base station 3212c. A second UE 3292 e.g., the UE 120, such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 21 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

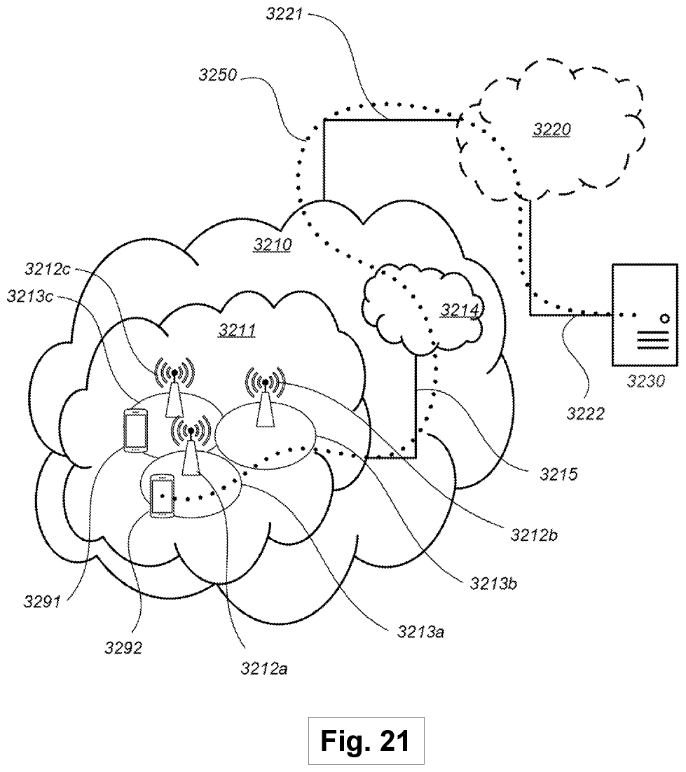

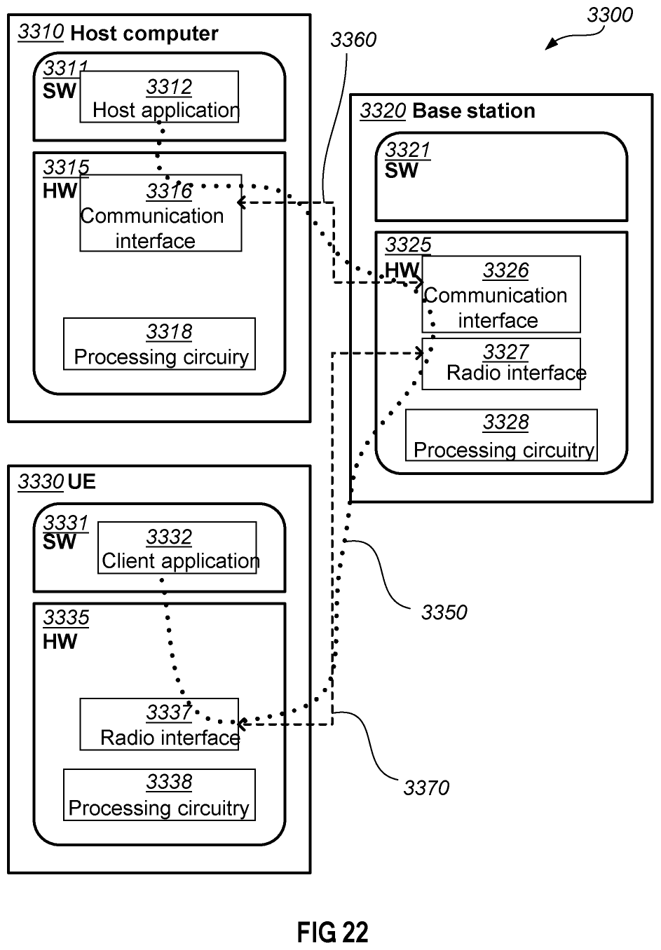

Example implementations, in accordance with an embodiment, of the UE, base station and host computer discussed in the preceding paragraphs will now be described with reference to FIG. 22. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown) served by the base station 3320. The communication interface 3326 may be configured to facilitate a connection 3360 to the host computer 3310. The connection 3360 may be direct or it may pass through a core network (not shown in FIG. 22) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 22 may be identical to the host computer 3230, one of the base stations 3212a, 3212b, 3212c and one of the UEs 3291, 3292 of FIG. 21, respectively. This is to say, the inner workings of these entities may be as shown in FIG. 22 and independently, the surrounding network topology may be that of FIG. 21.

In FIG. 22, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the applicable RAN effect: data rate, latency, power consumption, and thereby provide benefits such as corresponding effect on the OTT service: e.g., reduced user waiting time, relaxed restriction on file size, better responsiveness, extended battery lifetime.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

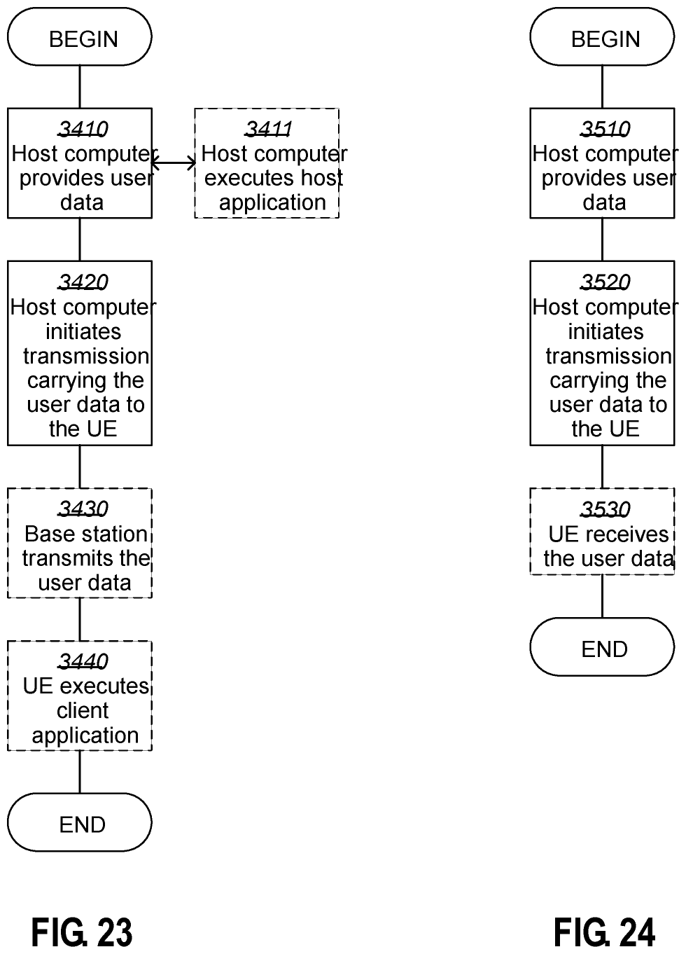

FIG. 23 is a flowchart illustrating a method implemented in a communication system, in accordance with one embodiment. The communication system includes a host computer, a base station such as the first, second, or third network node 111, 112, 113, and a UE such as the UE 120, which may be those described with reference to FIG. 21 and FIG. 22. For simplicity of the present disclosure, only drawing references to FIG. 23 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 24 is a flowchart illustrating a method implemented in a communication system, in accordance with one embodiment. The communication system includes a host computer, a base station such as an AP STA, and a UE such as a Non-AP STA which may be those described with reference to FIG. 21 and FIG. 22. For simplicity of the present disclosure, only drawing references to FIG. 24 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

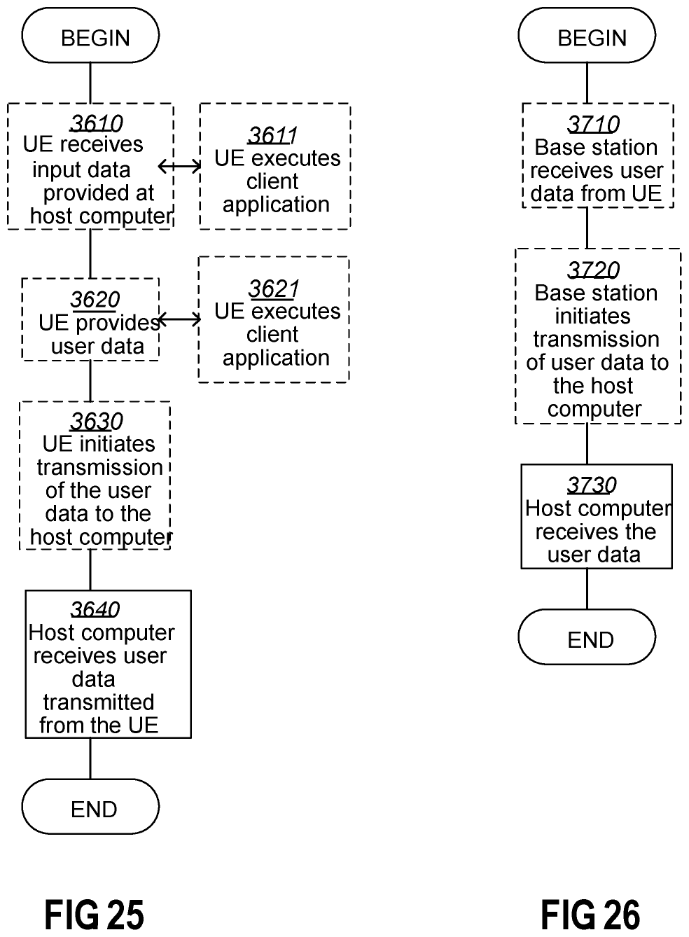

FIG. 25 is a flowchart illustrating a method implemented in a communication system, in accordance with one embodiment. The communication system includes a host computer, a base station such as an AP STA, and a UE such as a Non-AP STA which may be those described with reference to FIG. 21 and FIG. 22. For simplicity of the present disclosure, only drawing references to FIG. 25 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 26 is a flowchart illustrating a method implemented in a communication system, in accordance with one embodiment. The communication system includes a host computer, a base station such as an AP STA, and a UE such as a Non-AP STA which may be those described with reference to FIG. 21 and FIG. 22. For simplicity of the present disclosure, only drawing references to FIG. 26 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

1-40. (canceled)

41. A method for indicating a Secondary Cell Group (SCG) state during a Conditional Handover (CHO) in a wireless communications network, wherein the method is performed by a User Equipment (UE) or by a source Master Node (MN) and the UE is configured with a current SCG, and wherein the method comprises:
obtaining from a source MN, a CHO configuration for the UE, which CHO configuration comprises a configuration for a target candidate node, which target candidate node comprises any one or more out of: a target candidate MN and a target candidate Secondary Node (SN); and
responsive to CHO execution conditions related to the CHO configuration being fulfilled, sending an indication to the target candidate node, which indication indicates an SCG state being set to any one out of: SCG activated or SCG deactivated.

42. The method according to claim 41, wherein the SCG state is set according to any one out of the current SCG state, and/or a target SCG state.

43. The method according to claim 41, further comprising:
obtaining, the current SCG state, which current SCG state is set to any one out of: SCG activated or SCG deactivated,
and wherein the indication to the target candidate node indicates the current SCG state, which indication will set a target SCG state to SCG activation or SCG deactivation, initiated by the selected target candidate node.

44. The method according to claim 41, wherein:
obtaining, a target SCG state to any one out of:
always deactivated,
always activated,
a value pre-configured, as activated, or deactivated,
a the latest SCG state the UE has when CHO is executed, and
wherein the indication to the target candidate node indicates the target SCG state.

45. A method performed by a first network node acting as a source Master Node (MN) for handling a Secondary Cell Group (SCG) state during a Conditional Handover (CHO) for a User Equipment (UE) in a wireless communications network, wherein the UE is configured with a current SCG and wherein the method comprises:
sending to the UE, a Conditional Handover (CHO) configuration for the UE, which CHO configuration comprises a configuration for a target candidate node, which target candidate node comprises any one or more out of: a target candidate Master Node, MN, and a target candidate Secondary Node, SN;
wherein, responsive to CHO execution conditions relating to the CHO configuration being fulfilled, the UE sends an indication to the target candidate node, which indication indicates an SCG state being set to any one out of: SCG activated or SCG deactivated.

46. The method according to claim 45, wherein SCG state comprises any one out of the current SCG state, and/or a target SCG state.

47. The method according to claim 45, further comprising:
sending to the UE, a current SCG state, which current SCG state is set to any one out of: SCG activated or SCG deactivated,
and wherein the indication to the target candidate node indicates the current SCG state, which indication will set a target SCG state to SCG activation or SCG deactivation, initiated by the selected target candidate node.

48. The method according to claim 45, further comprising:
configuring the UE with a target SCG state set to any one out of:
always deactivated,
always activated,
a value pre-configured as activated or deactivated,
a latest SCG state the UE has when CHO is executed, and
and wherein the indication indicates the target SCG state.

49. A method performed by a second network node acting as a target Master Node (MN) for handling a Secondary Cell Group (SCG) state during a Conditional Handover (CHO) for a User Equipment (UE) in a wireless communications network, wherein the UE is configured with a current SCG and the method comprises:
based on CHO execution conditions relating to a CHO configuration being fulfilled, receiving an indication from the UE indicating whether an SCG state is set to activated or deactivated.

50. The method according to claim 49, wherein SCG state comprises any one out of the current SCG state, and/or a target SCG state.

51. The method according to claim 49, further comprising setting a target SCG state to SCG activation or SCG deactivation, based on the indication.

52. The method according to claim 49, comprising any one out of:
responsive to the indication indicating that a target SCG state comprises deactivated, activating the SCG after CHO execution, depending on the traffic assessment after CHO execution;
responsive to the indication indicating a target SCG state comprises activated, deactivating the SCG after CHO execution, depending on the traffic assessment after CHO execution;
responsive to the indication indicating a target SCG state comprises a pre-configured, value as activated or deactivated, deactivating the SCG after CHO execution, depending on the traffic assessment after CHO execution.

53. A method performed by a third network node acting as a target Secondary Node (SN) for handling a Secondary Cell Group (SCG) state during a Conditional Handover (CHO) for a User Equipment (UE) in a wireless communications network, wherein the UE is configured with a current SCG and the method comprises:
based on CHO execution conditions relating to a CHO configuration being fulfilled, receiving an indication from the UE, which indication indicates an SCG state being set to any one out of: SCG activated or SCG deactivated.

54. The method according to claim 53, wherein SCG state comprises any one out of the current SCG state, and/or a target SCG state.

55. The method according to claim 53, further comprising, responsive to the indication indicating a current SCG state, setting a target SCG state to SCG activation or SCG deactivation, based on the indication.

56. The method according to claim 53, comprising any one out of:
responsive to the indication indicating a target SCG state comprises deactivated, activating the SCG after CHO execution, depending on the traffic assessment after CHO execution;
responsive to the indication indicating a target SCG state comprises activated, deactivating the SCG after CHO execution, depending on the traffic assessment after CHO execution;
responsive to the indication indicating a target SCG state comprises a pre-configured, value as activated or deactivated, deactivating the SCG after CHO execution, depending on the traffic assessment after CHO execution.

57. A User Equipment (UE) or a source Master Node (MN) configured to indicate a Secondary Cell Group (SCG) state during a Conditional Handover (CHO) in a wireless communications network, wherein the UE or source MN is configured with a current SCG and wherein the UE or the source MN comprises:
a processor; and
a memory storing instructions that, when executed by the processor, cause the processor to control the UE or the source MN to:
obtain a Conditional Handover (CHO) configuration for the UE, comprising a configuration for a target candidate node, wherein the target candidate node comprises any one or more out of: a target candidate MN and a target candidate Secondary Node (SN);
responsive to fulfillment of CHO execution conditions related to the CHO configuration, send an indication to the target candidate node, indicating an SCG state being set to any one out of: SCG activated or SCG deactivated.

58. The UE or the source MN according to claim 57, wherein the SCG state is set in dependence on one or both of the current SCG state and a target SCG state.

59. The UE or the source MN according to claim 57, further configured to:
obtain a current SCG state, which current SCG state is any one out of: SCG activated or SCG deactivated;
and wherein the indication to the target candidate node indicates the current SCG state, which indication will set a target SCG state to SCG activation or SCG deactivation, initiated by the selected target candidate node.

60. The UE or the source MN according to claim 57, further configured to:
obtain a target SCG state adapted to be any one out of:
always deactivated,
always activated,
a value pre-configured, as activated or deactivated,
a latest SCG state the UE has when CHO is executed, and
wherein the indication to the target candidate node indicates the target SCG state.

61. A first network node acting as a source Master Node (MN) configured to handle a Secondary Cell Group (SCG) state during a Conditional Handover (CHO) for a User Equipment (UE) in a wireless communications network, wherein the UE is arranged to be configured with a current SCG and wherein the first network node comprises:
a processor; and
a memory storing instructions that, when executed by the processor, configure the processor to cause the first network node to:
send a Conditional Handover (CHO) configuration to the UE, the CHO configuration comprising a configuration for a target candidate node, and wherein the target candidate node comprises any one or more out of: a target candidate Master Node (MN) and a target candidate Secondary Node (SN); and
wherein fulfillment of CHO execution conditions triggers the UE to send an indication to the target candidate node, indicating an SCG state being set to any one out of: SCG activated or SCG deactivated.

62. The first network node according to claim 61, wherein the SCG state comprises any one out of the current SCG state and/or a target SCG state.

63. The first network node according to claim 61, further configured to:
send to the UE, a current SCG state, which current SCG state is set to any one out of: SCG activated or SCG deactivated,
and wherein the indication to the target candidate node indicates the current SCG state, which indication will set a target SCG state to SCG activation or SCG deactivation, initiated by the selected target candidate node.

64. The first network node according to claim 61, further being configured to: configure the UE with a target SCG state set to any one out of:
always deactivated,
always activated,
a value pre-configured as activated or deactivated,
a latest SCG state the UE has when CHO is executed, and
wherein the indication indicates the target SCG state.

65. A second network node acting as a target Master Node (MN) configured to handle a Secondary Cell Group (SCG) state during a Conditional Handover (CHO) for a User Equipment (UE) in a wireless communications network, wherein the UE is configured with a current SCG, and the second network node comprises:
a processor; and
a memory storing instructions that, when executed by the processor, cause the processor to control the second network node to:
in dependence on CHO execution conditions relating to a CHO configuration being fulfilled, receive an indication from the UE, indicating an SCG state being set to any one out of: SCG activated or SCG deactivated.
